(19) United States
(12) Patent Application Publication
(10) Pub. No.: US 2024/0372661 A1
(43) Pub. Date: Nov. 7, 2024

(54) Dynamic Slot Format Indications and WTRU Behaviors Associated with XDD

(71) Applicant: InterDigital Patent Holdings, Inc., Wilmington, DE (US)

(72) Inventors: Jonghyun Park, Syosset, NY (US); Moon IL Lee, Melville, NY (US); Paul Marinier, Brossard (CA); Young Woo Kwak, Woodbury, NY (US); Nazli Khan Beigi, Longueuil (CA)

(73) Assignee: InterDigital Patent Holdings, Inc., Wilmington, DE (US)

(21) Appl. No.: 18/689,016

(22) PCT Filed: Sep. 9, 2022
(86) PCT No.: PCT/US2022/043119

§ 371 Date: Mar. 4, 2024

Related U.S. Application Data
(60) Provisional application No. 63/395,969, filed on Aug. 8, 2022.
(60) Provisional application No. 63/244,471, filed on Sep. 15, 2021.

(51) Int. Cl. H04L 5/00; H04L 5/14

(52) U.S. Cl. CPC H04L 5/0044; H04L 5/14

(57) ABSTRACT

Systems, methods, and instrumentalities are disclosed herein associated with supporting flexible (e.g., subband-wise) slot format indications, which may include slot type(s) (e.g., new slot type(s)) of ‘Mₙ’ as a “Mixed” DL/UL. Tx/Rx rules for periodic/semi-persistent configurations according to a subband-wise slot type for XDD may be provided. A search space may be associated with multiple CORESETs. In examples, a WTRU may determine which CORESET to use for monitoring the search space based on the slot type (e.g., XDD slot or non-XDD slot). A WTRU may determine to monitor a search space in an XDD slot based on the “Mₙ” types and/or the number of search space resources re-allocated for the uplink in the slot. One or more search space sets may be configured and which search space set to monitor may be determined based on the slot type.

### CROSS-REFERENCE TO RELATED APPLICATIONS

This application claims priority to U.S. Provisional Patent Application No. 63/244,471, filed Sep. 15, 2021, and U.S. Provisional Patent Application No. 63/395,969, filed Aug. 8, 2022, which are incorporated by reference herein in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE). Wireless communication devices may establish communications with other devices and data networks, e.g., via an access network, such as a radio access network (RAN).

### SUMMARY

Systems, methods, and instrumentalities are disclosed herein associated with supporting flexible (e.g., subband-wise) slot format indications, which may include slot type(s) (e.g., new slot type(s) of ‘Mₙ’ as a “Mixed” DL/UL. The WTRU may receive a slot/symbol format indication that includes an ‘Mₙ’ type. In one or more cases, the Mₙ type may be associated with a first set of RBs (e.g., for UL) and a second set of RBs (e.g., for DL).

Tx/Rx rules for periodic/semi-persistent configurations according to a subband-wise slot type for XDD may be provided. In one or more cases, the WTRU may transmit an uplink channel/signal on one or more symbol(s) (e.g., a first group of symbol(s)). For example, the WTRU may transmit an uplink channel/signal on the first group of symbol(s) when the first group of symbol(s) are indicated by an ‘Mₙ’ type (e.g., n=1, or 2, . . . ) and the first set of RBs for the ‘Mₙ’ type includes one or more RB(s) allocated for the uplink channel/signal. In one or more cases, the WTRU may receive a downlink channel/signal on one or more symbol(s) (e.g., a second group of symbol(s)). For example, the WTRU may receive a downlink channel/signal on the second group of symbol(s) when the second group of symbol(s) are indicated by an ‘Mₙ’ type (n=1, or 2, . . . ) and the second set of RBs for the ‘Mₙ’ type includes one or more RB(s) allocated for the downlink channel/signal.

A search space may be associated with multiple CORESETs. In examples, a WTRU may determine which CORESET to use for monitoring the search space based on the slot type (e.g., XDD slot or non-XDD slot). A WTRU may determine to monitor a search space in an XDD slot based on the ‘Mₙ’ types and/or the number of search space resources re-allocated for the uplink in the slot. One or more search space sets may be configured and the search space set to monitor may be determined based on the slot type.

In one or more cases, a WTRU may be configured by higher layers or (e.g., dynamically) scheduled to transmit a UL signal (e.g., PUSCH, PUCCH, PRACH, a UL RS, etc.) in a resource. The WTRU may transmit the UL signal if the resource is valid for UL transmission based on (e.g., being included in) at least one UL SB(s) indicated by at least one sub-band non-overlapping full duplex (SBFD) (e.g., or XDD) signaling. In one or more cases, on a condition that the WTRU determines that the resource is valid for UL transmissions based on the at least one UL SB(s) in a symbol/slot, the WTRU may skip (e.g., drop, cease, skip as an exception case/operation, not conduct, fail to perform) monitoring/receiving a control channel (e.g., PDCCH, DCI(s). Thus, on the condition being met, skipping monitoring of the control channel (e.g., DCI(s)) via the control channel based on CORESET(s), in the symbol/slot, may reduce WTRU complexity and improve efficiency in communications with SBFD.

In one or more cases, the WTRU may be configured to implement NR-duplex operations based on sub-band non-overlapping full duplex (SBFD).

In one or more cases, the WTRU may be configured to receive information (e.g., via DCI or MAC CE) indicating that a first subset of resource blocks (RBs) of a plurality of resource blocks associated with one or more symbols are RBs for downlink (DL) reception. Additionally and/or alternatively, the WTRU may be configured to receive information (e.g., via DCI or MAC CE) indicating that a second subset of RBs of the plurality of RBs associated with the one or more symbols are RBs for uplink (UL) transmission.

In one or more cases, the WTRU may be configured to receive a DL transmission associated with periodic DL resources (e.g., PDCCH/CG-PDSCH) in the one or more symbols on a condition that the periodic DL resources are comprised in the first subset of RBs indicated by the information to be RBs for DL reception. In one or more cases, the WTRU may be configured to send a UL transmission associated with periodic UL resources (e.g., PUCCH/CG-PUSCH) in the one or more symbols. For example, in some cases, the WTRU may be configured to send a UL transmission associated with periodic UL resources (e.g., PUCCH/CG-PUSCH) in the one or more symbols on a condition that the periodic UL resources are comprised in the second subset of RBs indicated by the information to be RBs for UL reception.

In one or more cases, the WTRU may be configured to receive configuration information (e.g., via RRC) indicating a plurality of UL/DL RB configurations. In one or more cases, the information (e.g., received via the DCI and/or the MAC-CE) may indicate which of the plurality of UL/DL RB configurations to apply for the one or more symbols. In one or more cases, the WTRU may be configured to drop at least one other UL transmission associated with periodic UL resources (e.g., PUCCH/CG-PUSCH). In one or more cases, the WTRU may be configured to drop at least one other UL transmission associated with periodic UL resources (e.g., PUCCH/CG-PUSCH) in the one or more symbols on a condition that the periodic UL resources are comprised in the first set of RBs indicated by the information to be RBs for DL reception.

The WTRU may receive an indication that each of one or more symbols include both a first subset resource blocks associated with downlink (DL) reception and a second subset of resource blocks associated with uplink (UL) transmission. The WTRU may receive a DL transmission associated with one or more periodic DL resources in the one or more symbols on a condition that the one or more periodic DL resources are comprised in the first subset of resource blocks associated with DL reception for the one or more symbols. For example, the one or more periodic DL resources may be for one or more of a physical downlink control channel (PDCCH) or a configured grant-physical downlink shared channel (CG-PDSCH). The WTRU may transmit a first UL transmission associated with one or more periodic UL resources in the one or more symbols on a condition that the one or more periodic UL resources are comprised in the second subset of resource blocks associated with UL transmission for the one or more symbols. For example, the periodic UL resources may be for one or more of a physical uplink control channel (PUCCH) or a configured grant-physical uplink shared channel (CG-PUSCH).

The WTRU may receive configuration information (e.g., in a radio resource control (RRC) message), the configuration information indicating a plurality of UL/DL resource block patterns for the one or more symbols. The plurality of UL/DL resource block patterns may be indicated using a bitmap, for example. The indication may be received via downlink control information (DCI) or a medium access control (MAC) control element (CE), and may indicate which of the plurality of UL/DL resource block patterns indicated in the configuration information is to be applied for the one or more symbols. The indication may indicate that a first UL/DL resource block pattern of the plurality of UL/DL resource block patterns is to be applied for a first symbol of the one or more symbols, and that a second UL/DL resource block pattern of the plurality of UL/DL resource block patterns is to be applied for a second symbol of the one or more symbols.

The WTRU may drop a second UL transmission associated with one or more second periodic UL resources in the one or more symbols on a condition that the one or more second periodic UL resources are comprised in the first subset of resource blocks associated with DL reception for the one or more symbols. The WTRU may fail to receive a second DL transmission associated with one or more second periodic DL resources in the one or more symbols on a condition that the one or more second periodic DL resources are comprised in the second subset of resource blocks associated with UL reception for the one or more symbols.

### BRIEF DESCRIPTION OF THE DRAWINGS

FIG. 1A is a system diagram illustrating an example communications system.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A.

FIG. 2 shows an example of FD-gNB and HD-WTRUs in a cell.

FIG. 3 shown an example of ‘M₁’ type.

FIG. 4 shows an example of ‘M₂’ type.

FIG. 5 illustrates an example subband non-overlapping full duplex (SBFD).

FIG. 6 illustrates examples of SBFD operations based on Mixed UL/DL types (Mₙ).

FIG. 7 shows an example of subband BWP-wise dynamic muting for XDD.

### DETAILED DESCRIPTION

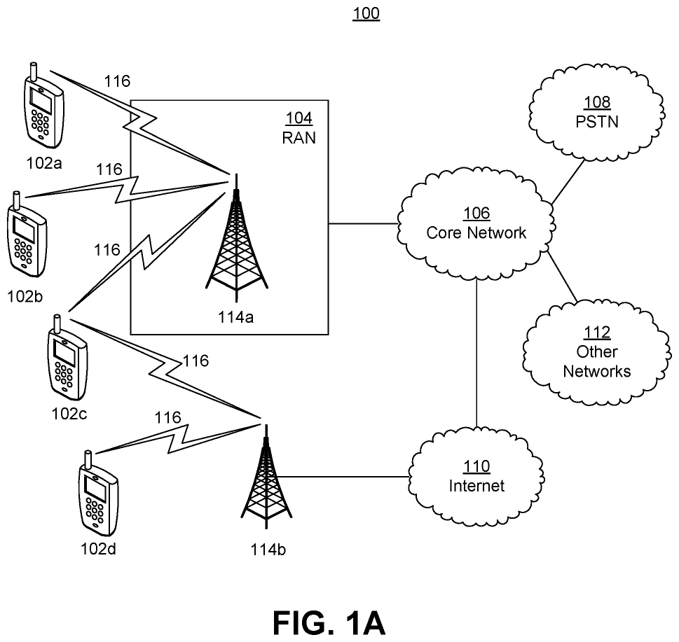

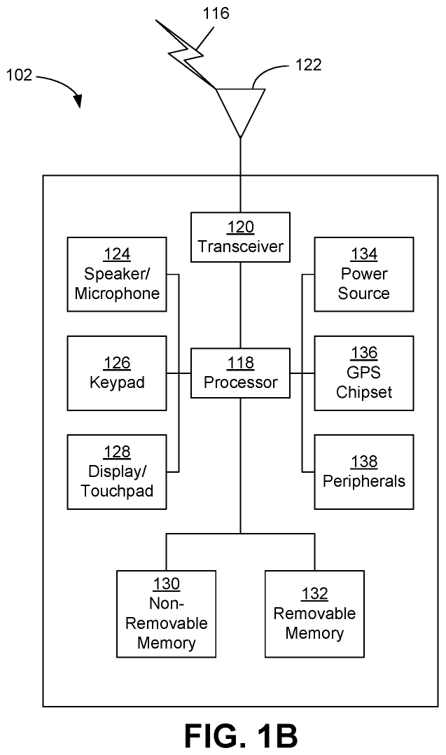

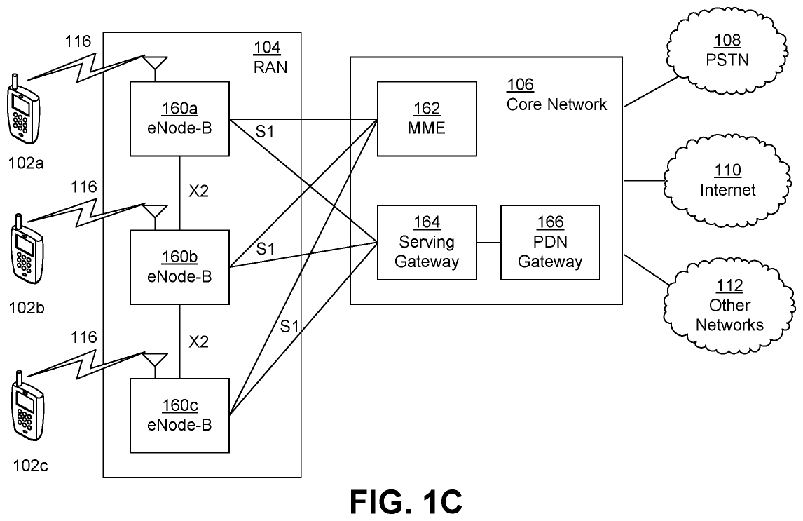

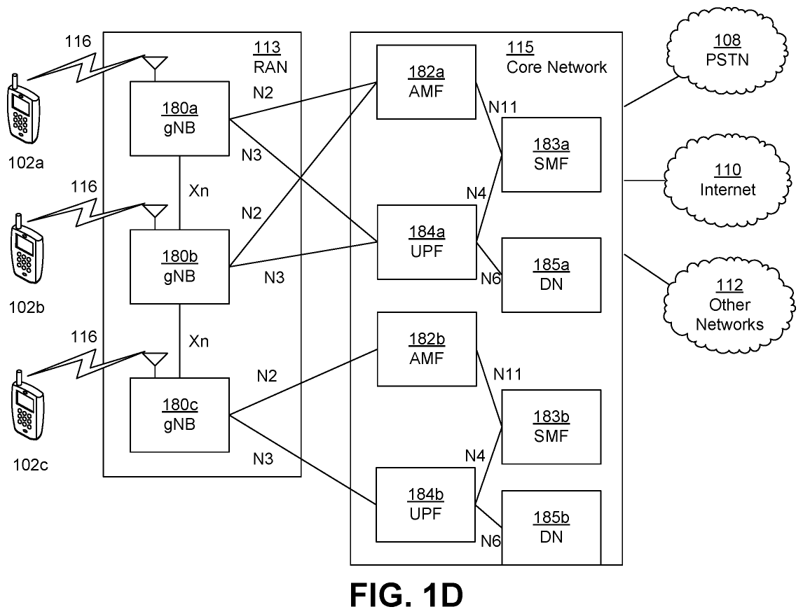

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHZ channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms, among others, are used herein: Configuration grant (CG); Dynamic grant (DG); MAC control element (MAC CE); Acknowledgement (ACK); Block Error Rate (BLER); Bandwidth Part (BWP); Cyclic Prefix (CP); Conventional OFDM (relying on cyclic prefix) (CP-OFDM); Channel Quality Indicator (CQI); Cyclic Redundancy Check (CRC); Channel State Information (CSI); Downlink Assignment Index (DAI); Downlink Control Information (DCI); Downlink (DL); Demodulation Reference Signal (DM-RS); Data Radio Bearer (DRB); Hybrid Automatic Repeat Request (HARQ); Long Term Evolution (LTE) e.g., from 3GPP LTE R8 and up; Negative ACK (NACK); Modulation and Coding Scheme (MCS); Multiple Input Multiple Output (MIMO); New Radio (NR); Orthogonal Frequency-Division Multiplexing (OFDM); Physical Layer (PHY); Physical Random Access Channel (PRACH); Primary Synchronization Signal (PSS); Random Access Channel (or procedure) (RACH); Random Access Response (RAR); Radio Front end (RF); Radio Link Failure (RLF); Radio Link Monitoring (RLM); Radio Network Identifier (RNTI); Radio Resource Control (RRC); Radio Resource Management (RRM); Reference Signal (RS); Reference Signal Received Power (RSRP); Received Signal Strength Indicator (RSSI); Service Data Unit (SDU); Sounding Reference Signal (SRS); Synchronization Signal (SS); Secondary Synchronization Signal (SSS); Semi-persistent scheduling (SPS); Simultaneous Transmission from Multiple Panels (STxMP); Supplemental Uplink (SUL); Transport Block (TB); Transport Block Size (TBS); Transmission/Reception Point (TRP); Uplink (UL); Ultra-Reliable and Low Latency Communications (URLLC); Wireless Local Area Networks and related technologies (IEEE 802.xx domain) (WLAN); Time Division Duplex (TDD); Cross Division Duplex (XDD); Full Duplex (FD); Half Duplex (HD); Integrated Access and Backhaul (IAB); Self-Interference (SI); Cross-Link Interference (CLI); Physical Downlink Shared Channel (PDSCH); Physical Uplink Shared Channel (PUSCH); Physical Downlink Control Channel (PDCCH); Physical Uplink Control Channel (PUCCH); Control Resource Set (CORESET); Sounding Reference Signal (SRS); User Equipment (UE); Power Control (PC); Resource Block (RB); Layer1-RSRP (L1-RSRP); CSI-RS resource indicator-RSRP (cri-RSRP); Synchronization Signal Block (SSB); Signal-to-Interference-plus-Noise Ratio (SINR); Transmission Configuration Indicator (TCI); Open Loop Power Control (OLPC); Closed Loop Power Control (CLPC); Pathloss (PL); Power Management-Maximum Power Reduction (P-MPR); Power Headroom (PH); Power Headroom Reporting (PHR); Uplink Control Information (UCI); SRS Resource Indicator (SRI); Sidelink (Side Link) (SL); SL Control Information (SCI); massive Machine Type Communications (mMTC); and Non-Terrestrial Network (NTN).

New radio (NR) may support dynamic time division duplex (TDD) by a group-common (GC) DCI (e.g., format 2_0 as shown in Table 1) indicating a slot format and/or semi-static configurations of tdd-UL-DL-config-common/dedicated, where a (e.g., each) slot/symbol may comprise one or more of ‘DL’, ‘UL’, and/or ‘Flexible’ configurations. For example, tdd-UL-DL-config-common (e.g., TDD-UL-DL-ConfigCommon) may be an RRC parameter for a cell-specific UL/DL TDD configuration, and tdd-UL-DL-config-dedicated (e.g., TDD-UL-DL-ConfigDedicated) may be an RRC parameter for a WTRU-specific UL/DL TDD configuration

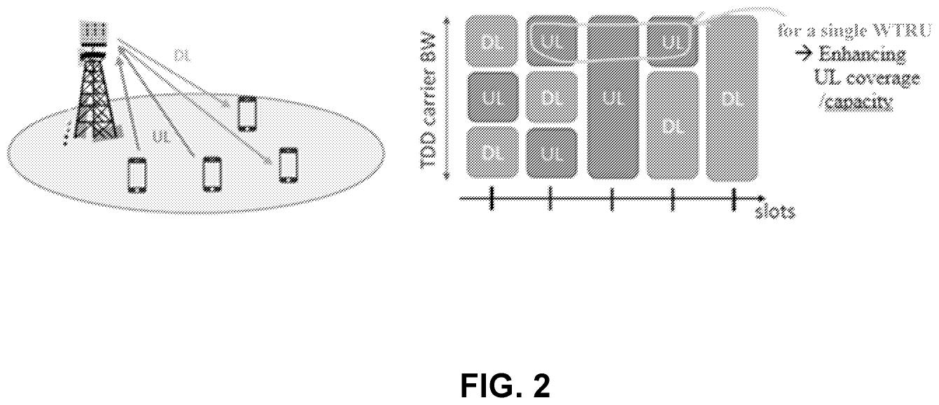

In examples, duplexing may include half duplex (HD) for gNBs and WTRUs. Enhancements to support full duplex (FD) for gNBs and/or for WTRUs including integrated access and backhaul (IAB) devices may be provided. Cross division duplex (XDD) (e.g., sub-band level FD as illustrated in FIG. 2) may be used and, for example, may offer reduced FD implementation complexity, e.g., in terms of cancelling self-interference (SI) and mitigating cross-link interference (CLI), at least at the transmitter (e.g., at the gNB).

TABLE 1
Slot formats for normal cyclic prefix

| For- | Symbol number in a slot | | | | | | | | | | | | | |
|---|---|---|---|---|---|---|---|---|---|---|---|---|---|---|
| mat | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |

. . .

| | | | | | | | | | | | | | | |
|---|---|---|---|---|---|---|---|---|---|---|---|---|---|---|
| 54 | F | F | F | F | F | F | F | D | D | D | D | D | D | D |
| 55 | D | D | F | F | F | U | U | U | D | D | D | D | D | D |

| | |
|---|---|
| 56- | Reserved |
| 254 | |
| 255 | UE determines the slot format for the slot |
| | based on tdd-UL-DL-ConfigurationCommon, |
| | or tdd-UL-DL-ConfigurationDedicated |
| | and, if any, on detected DCI formats |

FIG. 2 shows an example of FD-gNB and HD-WTRUs in a cell. In terms of resource muting perspective, NR may support interrupted transmission (INT) (e.g., downlink preemption) by a DCI (e.g., format 2_1) to dynamically indicate no transmission to a WTRU is present in its active DL BWP(s) of one or more cells and/or to use the resource for other purposes (e.g., URLLC). NR may support cancellation indication (CI) by a DCI (e.g., format 2_4) to dynamically cancel a scheduled PUSCH and/or SRS in a configured timeFrequencyRegion of one or more cells. NR may support (e.g., for PDSCH) semi-static resource muting patterns (e.g., rateMatchPatternGroup1 & 2 such as reserved resources for RB level) and/or semi-static/dynamic rate matching commands by ZP-CSI-RS (e.g., for RE level).

In a deployment employing a dynamic TDD, a component carrier (CC) and/or a bandwidth part (BWP) may include one type among downlink (‘D’), uplink (‘U’), and flexible (‘F’) in a symbol/slot, for example, depending on the GC-DCI (e.g., format 2_0) comprising a slot format indicator (SFI) and/or tdd-UL-DL-config-common/dedicated configurations. For XDD operations, a communication direction (e.g., such as ‘U’) for a WTRU may have a mismatch if other WTRU(s) have a different communication direction (e.g., ‘D’). For example, if the mismatch occurs on a subband, the subband may be exposed to a WTRU-to-WTRU cross-link interference (CLI). In examples, a WTRU may be configured with various types of periodic/semi-persistent DL receptions (e.g., SPS-PDSCH) and/or UL transmissions (e.g., configured-grant (CG) PUSCH). Periodic/semi-persistent configurations of DL/UL along with the exposed WTRU-to-WTRU CLI issues on dynamic XDD operations may be handled.

The term “subband” may be used to refer to a frequency-domain resource and may be characterized by at least one of the following: a set of resource blocks (RBs), a set of RB sets (e.g., if a carrier includes intra-cell guard bands), a set of interlaced resource blocks, a bandwidth part (e.g., or portion thereof), or a carrier (e.g., or portion thereof).

A subband may be characterized by a starting RB and a number of RBs for a set of contiguous RBs within a bandwidth part. A subband may be defined by the value of a frequency-domain resource allocation field and/or bandwidth part index.

The term “XDD” may be used to refer to a subband-wise duplex (e.g., UL or DL being used per subband) and/or may be characterized by at least one of the following: Cross Division Duplex (e.g., subband-wise FDD within a TDD band), subband-based full duplex (e.g., full duplex as UL and DL are used/mixed on a symbol/slot and UL or DL being used per subband on the symbol/slot), frequency-domain multiplexing (FDM) of DL/UL transmissions within a TDD spectrum, a subband non-overlapping full duplex (e.g., non-overlapped sub-band full-duplex), a full duplex other than a same-frequency full duplex (e.g., spectrum sharing, subband-wise overlapped full duplex), or an advanced duplex method (e.g., other than pure TDD or FDD).

The term “Dynamic (/flexible) TDD” may be used to refer to a TDD system/cell that may dynamically (e.g., and/or flexibly) change/adjust/switch a communication direction (e.g., a downlink, an uplink, or a sidelink, etc.) for a time instance (e.g., slot, symbol, subframe, and/or the like). For example, in a system that employs dynamic/flexible TDD, a component carrier (CC) or a bandwidth part (BWP) may have a single type among ‘D’, ‘U’, and ‘F’ on a symbol/slot. In some cases, the CC or BWP may have the one single type on the symbol/slot based on an indication by a group-common (GC)-DCI (e.g., format 2_0) including a slot format indicator (SFI), and based on tdd-UL-DL-config-common/dedicated configurations. In some cases, the CC or BWP may have the single type on the symbol/slot based on an indication by a group-common (GC)-DCI (e.g., format 2_0) including a slot format indicator (SFI). In some cases, the CC or BWP may have the single type on the symbol/slot based on tdd-UL-DL-config-common/dedicated configurations. For a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB. For the given time instance/slot/symbol, a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In one or more cases, the first WTRU may determine that the uplink signal interferes with the reception of the downlink signal, in which the interference caused by the uplink signal may be referred to as WTRU-to-WTRU cross-layer interference (CLI).

In one or more cases, the WTRU may transmit or receive a physical channel or reference signal according to at least one spatial domain filter. The term “beam” may refer to a spatial domain filter.

In one or more cases, the WTRU may transmit a physical channel or signal using the same spatial domain filter as the spatial domain filter used for receiving an RS (e.g., CSI-RS) or an SS block. In one or more cases, the WTRU transmission may be referred to as a “target”. In one or more cases, the received RS or SS block may be referred to as a “reference” or “source”. In such cases, the WTRU may be used to transmit the target physical channel or signal. In some cases, the WTRU may be used to transmit the target physical channel or signal according to a spatial relation with a reference to an RS or SS block.

In one or more cases, the WTRU may transmit a first physical channel or signal according to the same spatial domain filter as the spatial domain filter used for transmitting a second physical channel or signal. The first and second transmissions may be referred to as the “target” and the “reference” (or “source”), respectively. In such cases, the WTRU may transmit the first (e.g., target) physical channel or signal according to a spatial relation with a reference to the second (e.g., reference) physical channel or signal.

In one or more cases, the spatial relation may be implicit. In one or more cases, the spatial relation may be configured by RRC. In one or more cases, the spatial relation may be signaled by MAC CE or DCI. For example, the WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may be referred to as a “beam indication”.

In one or more cases, the WTRU may receive a first (e.g., target) downlink channel or signal according to the same spatial domain filter or spatial reception parameter as a second (e.g., reference) downlink channel or signal. For example, such association may exist between a physical channel, such as PDCCH or PDSCH, and its respective DM-RS. In one or more cases, when the first and second signals are reference signals, such association may exist when the WTRU is configured with a quasi-colocation (QCL) assumption type D between corresponding antenna ports. In one or more cases, when the first and second signals are reference signals, such association may be configured as a TCI (transmission configuration indicator) state. The WTRU may be indicated of an association between a CSI-RS or SS block and a DM-RS by an index to a set of TCI states configured by RRC and/or signaled by MAC CE. The indication of the association may be referred to as a “beam indication”.

In one or more cases, the term “TRP” (e.g., transmission and reception point) may be interchangeably used with one or more of the terms TP (transmission point), RP (reception point), RRH (radio remote head), DA (distributed antenna), BS (base station), a sector (of a BS), and a cell (e.g., a geographical cell area served by a BS). In one or more cases, the term “multi-TRP” may be interchangeably used with one or more of the terms MTRP, M-TRP, and multiple TRPs.

In one or more cases, the WTRU may report a subset of channel state information (CSI) components. In one or more cases, CSI components may correspond to one or more of a CSI-RS resource indicator (CRI), a SSB resource indicator (SSBRI), an indication of a panel used for reception at the WTRU (e.g., such as a panel identity or group identity), measurements such as L1-RSRP, L1-SINR taken from SSB or CSI-RS (e.g., cri-RSRP, cri-SINR, ssb-Index-RSRP, ssb-Index-SINR), and other channel state information, such as a rank indicator (RI), channel quality indicator (CQI), precoding matrix indicator (PMI), Layer Index (LI), and the like.

In one or more cases, the WTRU may be configured to receive and/or provide one or both of channel measurements and interference measurements. In one or more cases, with respect to Synchronization Signal Block (SSB), the WTRU may receive a synchronization signal/physical broadcast channel (SS/PBCH) block. The SS/PBCH block (SSB) may include a primary synchronization signal (PSS), secondary synchronization signal (SSS), and/or physical broadcast channel (PBCH). The WTRU may monitor, receive, or attempt to decode an SSB during initial access, initial synchronization, radio link monitoring (RLM), cell search, cell switching, and so forth.

With respect to CSI-RS, the WTRU may measure and report channel state information (CSI). In one or more cases, the CSI for a (e.g., each) connection mode may include or be configured with one or more of CSI Report Configuration, CSI-RS resource set, and/or NZP CSI-RS Resources. In one or more cases, the CSI Report Configuration may include one or more of the following: CSI report quantity (e.g., Channel Quality Indicator (CQI), Rank Indicator (RI), Precoding Matrix Indicator (PMI), CSI-RS Resource Indicator (CRI), Layer Indicator (LI), and other like indicators); CSI report type (e.g., aperiodic, semi-persistent, periodic, and other reporting time periods); CSI report codebook configuration (e.g., Type I, Type II, Type II port selection, etc.); and/or CSI report frequency. For example, the CSI report quantity may be a parameter reportQuantity, which may be used to indicate one or more of cri-RI-PMI-CQI, cri-RI-CQI, cri-RSRP, and/or ssb-Index-RSRP. The CSI report quantity may indicate what values to report as a part of CSI reporting. For example, if the parameter reportQuantity is set to cri-RI-PMI-CQI, the WTRU may report, as a CSI reporting procedure, one or more of CRI, RI, PMI, and/or CQI, according to the CSI reporting related configuration. In one or more cases, the CSI-RS Resource set may include one or more of the following CSI Resource settings: NZP-CSI-RS Resource for channel measurement, NZP-CSI-RS Resource for interference measurement; and/or CSI-IM Resource for interference measurement. In one or more cases, the NZP CSI-RS Resources may include one or more of the following: NZP CSI-RS Resource ID, periodicity and offset, QCL information and TCI-state, and/or resource mapping (e.g., number of ports, density, CDM type, and other resource mapping information).

In one or more cases, the WTRU may indicate, determine, and/or be configured with one or more reference signals. The WTRU may monitor, receive, and/or measure one or more parameters based on the respective reference signals. The parameters may include for example, but are not limited to, SS reference signal received power (SS-RSRP), CSI-RSRP, SS signal-to-noise and interference ration (SS-SINR), Received signal strength indicator (RSSI), Cross-Layer interference received signal strength indicator (CLI-RSSI), Sounding reference signals RSRP (SRS-RSRP). In one or more cases, one or more of the parameters may be included in reference signal(s) measurements.

In one or more cases, SS-RSRP may be measured based on the synchronization signals (e.g., demodulation reference signal (DMRS) in PBCH or SSS). In one or more cases, SS-RSRP may be the linear average over the power contribution of the resource elements (RE) that carry the respective synchronization signal. In measuring RSRP, the power for the reference signals may be scaled. In cases where SS-RSRP is used for L1-RSRP, the measurement may be determined based on CSI reference signals (e.g., in addition to the synchronization signals).

In one or more cases, CSI-RSRP may be measured based on the linear average over the power contribution of the resource elements (RE) that carry the respective CSI-RS. The CSI-RSRP measurement may be configured within measurement resources for the configured CSI-RS occasions.

In one or more cases, SS-SINR may be measured based on the synchronization signals (e.g., DMRS in PBCH or SSS). In one or more cases, SS-SINR may be the linear average over the power contribution of the resource elements (RE) that carry the respective synchronization signal divided by the linear average of the noise and interference power contribution. In cases where the SS-SINR is used for L1-SINR, the noise and interference power measurement may be determined based on resources configured by higher layers.

In one or more cases, CSI-SINR may be measured based on the linear average over the power contribution of the resource elements (RE) that carry the respective CSI-RS divided by the linear average of the noise and interference power contribution. In cases that CSI-SINR is used for L1-SINR, the noise and interference power measurement may be determined based on resources configured by higher layers. In one or more other cases, the noise and interference power may be measured based on the resources that carry the respective CSI-RS.

In one or more cases, RSSI may be measured based on the average of the total power contribution in configured OFDM symbols and bandwidth. In one or more cases, the power contribution may be received from different resources (e.g., co-channel serving and non-serving cells, adjacent channel interference, thermal noise, and/or the like).

In one or more cases, CLI-RSSI may be measured based on the average of the total power contribution in configured OFDM symbols of the configured time and frequency resources. In one or more cases, the power contribution may be received from different resources (e.g., cross-layer interference, co-channel serving and non-serving cells, adjacent channel interference, thermal noise, and/or the like).

In one or more cases, SRS-RSRP may be measured based on the linear average over the power contribution of the resource elements (RE) that carry the respective SRS.

In one or more cases, a property of a grant or an assignment may include one or more of the following: a frequency allocation; an aspect of time allocation, such as a duration; a priority; a modulation and coding scheme; a transport block size; a number of spatial layers; a number of transport blocks; a TCI state, e.g., CRI or SRI; a number of repetitions; a determination of whether the repetition scheme is Type A or Type B; a determination of whether the grant is a configured grant type 1, configured grant type 2, or a dynamic grant; a determination of whether the assignment is a dynamic assignment or a semi-persistent scheduling (e.g., configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment. In one or more cases, an indication by DCI may include one or more of the following: an explicit indication by a DCI field or by RNTI used to mask CRC of the PDCCH; and/or an implicit indication by a property such as DCI format, DCI size, Coreset or search space, Aggregation Level, or first resource element of the received DCI (e.g., index of first Control Channel Element), in which the mapping between the property and the value may be signaled by RRC or MAC. It is noted that, as described herein, the term “RS” may be interchangeably used with one or more of the terms RS resource, RS resource set, RS port and RS port group. Moreover, it is noted that the term “RS” may be interchangeably used with one or more of the terms SSB, CSI-RS, SRS, and DM-RS.

Flexible (e.g., subband-wise) slot format indications may be provided. In examples, the WTRU may receive, for one or more subband(s), an indication of the set of frequency resources corresponding to the subband. The indication may consist of, for example, at least one of a starting RB, an ending RB, or a number of RBs. The WTRU may receive an indication for each subband applicable to one or more (e.g., all) time slots or time symbols. In examples, the WTRU may receive an indication for each subband applicable to a subset of time slots or time symbols, for at least one such subset.

Subband-specific slot format indication may be provided. In examples, a WTRU may receive an indication of a slot format for a plurality of subbands (e.g., each of a plurality of subbands). For a subband (e.g., each subband), the slot format may comprise an indication of whether each symbol is Downlink, Uplink, or Flexible. The indication(s) may be received via a DCI (e.g., a group-common DCI such as DCI format 2_0), e.g., from a position (e.g., configured as a starting bit location for the WTRU to read) of the DCI. The WTRU may receive the indication of slot format for a subband using at least one of the following features described herein.

In examples, the WTRU may receive, for one or more subband(s) (e.g., each of one or more subbands), configuration information such as a higher layer configuration information of slot format combinations applicable to the subband. The configuration information may include the same information as the slotformatcombinations information element (IE) of the existing system, for example, including a position in DCI (e.g., a group-common DCI such as DCI format 2_0). The WTRU may determine a first slot format combination and a second slot format combination applicable to a first subband and a second subband respectively, for example, by decoding the DCI in first and second positions in the DCI configured for first and second subband, respectively, e.g., where both the first and second positions (e.g., as parameters or values) may be configured to the WTRU.

In examples, the WTRU may receive (e.g., first receive) a higher layer configuration information of slot format combinations applicable to one or more (e.g., all) subbands, including a starting position in the DCI. The WTRU may receive at least one slot format combination sequentially from the starting position, for example, where a slot format combination (e.g., each slot format combination) is applicable to a subband.

In examples, the WTRU may receive configuration information for one or more multi-subband slot format combination(s), where a multi-subband slot format combination (e.g., each multi-subband slot format combination) comprises a set of slot formats for at least one subband. In examples, a first multi-subband slot format combination may include first and second slot formats for a first subband and first and second slot formats for a second subband. The WTRU may receive configuration information of an index for a configured multi-subband slot format combination (e.g., each configured multi-subband slot format combination). The WTRU may receive a multi-subband slot format combination index from a DCI at a configured subband position and may determine applicable slot formats for a subband (e.g., each subband).

Subband-specific UL-DL configuration information may be provided. The WTRU may receive UL-DL configuration information from higher layers for at least one subband (e.g., each of at least one subband). The higher layer configuration information may be applicable to the subband, for example, if a slot format indication is not received from a DCI or if the slot format indication has a special value (e.g., 255).

Applicability of transmission or reception rules with subband-specific slot format indication may be provided. A WTRU may be configured by higher layers to receive or transmit a signal or channel in a resource and/or in a slot where a subband-specific slot format indication is received. The WTRU may determine whether to receive or transmit in the resource as a function of the received subband-specific slot format indication according to one or more of the following.

In examples, a WTRU configured by higher layers to send a PUSCH transmission in a resource may transmit the PUSCH if (e.g., only if) for each subband overlapping with the PUSCH, the slot format indication is “uplink” for every symbol (e.g., or for a set of symbol(s)) of the PUSCH.

In examples, a WTRU configured by higher layers to send a PUSCH transmission in a resource may transmit the PUSCH if (e.g., only if) for more than S (e.g., S>1) subband(s) overlapping with the PUSCH, the slot format indication is “uplink” for every symbol (e.g., or for a set of symbol(s)) of the PUSCH. S (e.g., S>1) may be pre-defined, configured, and/or indicated.

Applicability of PDCCH monitoring behaviors may be provided. In one or more cases, the WTRU may be configured by higher layers or (dynamically) scheduled to transmit a UL signal (e.g., PUSCH, PUCCH, PRACH, a UL RS, etc.) in a resource. In one or more cases, the WTRU may transmit the UL signal if the resource is valid for UL transmission based on (e.g., being included in) at least one UL SB(s) indicated by at least one SBFD (or XDD) signaling, as discussed herein. In some cases in which the WTRU determines that the resource is valid for UL transmissions based on the at least one UL SB(s) in a symbol/slot, the WTRU may skip (e.g., drop, cease, skip as an exception case/operation, not conduct, fail to perform) monitoring/receiving a control channel (PDCCH), (e.g., monitoring DCI(s) via the control channel based on CORESET(s)), in the symbol/slot. As such, by skipping the monitoring or receiving of a control channel, the WTRU complexity may be reduced and therefore efficiency in communications with SBFD may be improved.

In one or more cases, in response to the WTRU determining that the resource is not valid for UL transmissions in a symbol/slot (e.g., not being included in UL SB(s), etc.), the WTRU may be configured to monitor a control channel (PDCCH) in the symbol/slot. For example, if the WTRU determines that the resource is not valid for the UL transmission in the symbol/slot, the WTRU may be configured to monitor DCI(s) via the control channel based on CORESET(s), in the symbol/slot.

In one or more cases, in response to the WTRU determining that the resource is not valid for UL transmissions in the symbol/slot (e.g., not being included in UL SB(s), etc.), the WTRU may be configured to skip (e.g., drop, cease, skip as an exception case/operation, not conduct, fail to perform) monitoring/receiving a control channel (PDCCH) (e.g., monitoring DCI(s) via the control channel based on CORESET(s) in the symbol/slot. As such, by skipping the monitoring or receiving of a control channel, the WTRU complexity may be reduced and therefore efficiency in communications with SBFD may be improved.

In examples, a WTRU configured by higher layers to receive PDSCH in a resource may receive PDSCH and may provide HARQ-ACK feedback if (e.g., only if), for each subband overlapping with the PDSCH, the slot format indication is “downlink” for every symbol (e.g., or for a set of symbol(s)) of the PDSCH.

In examples, a WTRU configured by higher layers to receive PDSCH in a resource may receive PDSCH and may provide HARQ-ACK feedback if (e.g., only if), for more than S (e.g., S>1) subband(s) overlapping with the PDSCH, the slot format indication is “downlink” for every symbol (e.g., or for a set of symbol(s)) of the PDSCH. S (e.g., S>1) may be pre-defined, configured, and/or indicated.

Slot type(s) of a “Mixed” DL/UL (e.g., denoted by ‘Mₙ’) may be provided. In examples, slot type(s) of a “Mixed” DL/UL (e.g., denoted by ‘Mₙ’, where n=1 or n=1, 2, . . . ) may be defined or configured (e.g., from a gNB) to a WTRU. An Mₙ type (e.g., defined or configured to the WTRU) may be used for indicating that a time instance (e.g., slot and/or symbol) may be used for at least one of the following: (UL) transmission(s) from the WTRU over a first set of RBs, (DL) reception(s) at the WTRU over a second set of RBs, or both (UL) transmission(s) from the WTRU over the first set of RBs and (DL) reception over the second set of RBs at the WTRU. The first set of RBs and/or the second set of RBs may be configured to be associated with the Mₙ type, for example, where a communication direction (e.g., DL or UL) may be configured/determined to be associated with either the first set of RBs or the second set of RBs, e.g., compared with a slot type ‘F’ not being associated with a set of RBs pre-associated with a communication direction.

The Mₙ type may be used and/or included in a parameter for tdd-UL-DL-config, for example, which may include one or more time instances, a (e.g., each) time instance indicating and/or comprising at least one of ‘D’, ‘U’, ‘F’, or ‘Mₙ’. The parameter for tdd-UL-DL-config may be a cell-specific (e.g., or cell-common) parameter (e.g., tdd-UL-DL-ConfigurationCommon) or a WTRU-dedicated parameter (e.g., tdd-UL-DL-ConfigurationDedicated).

In examples, the Mₙ type (e.g., defined or configured to the WTRU) may indicate (e.g., comprise or be associated with) at least one of the following frequency-domain resource-wise information contents (e.g., explicitly or implicitly): a first set of RBs for UL usage (e.g., or DL usage), a second set of RBs for DL usage (e.g., or UL usage), or a third set of RBs for “Flexible” usage between DL/UL. In examples, a first set of RBs for UL usage (e.g., or DL usage) may be configured by a RB(s)-level bitmap or identified and/or configured by which region(s) of divided regions (e.g., evenly divided regions) within a BWP (e.g., a currently active BWP and/or CC), for example, which may include an explicit indicator to indicate which region(s) may be applicable for a given usage (e.g., for DL or for UL). The WTRU may receive an indication of the RB(s)-level bitmap via a radio resource control (RRC) message that indicates a plurality of UL/DL resource block patterns for one or more symbols. The WTRU may receive an indication via downlink control information (DCI) or a medium access control (MAC) control element (CE) that may indicate which of the plurality of UL/DL resource block patterns indicated in the configuration information is to be applied for the one or more symbols. For example, the indication may indicate that a first UL/DL resource block pattern of the plurality of UL/DL resource block patterns is to be applied for a first symbol of the one or more symbols, and that a second UL/DL resource block pattern of the plurality of UL/DL resource block patterns is to be applied for a second symbol of the one or more symbols.

In examples, a second set of RBs for DL usage (e.g., or UL usage) may be configured by a RB(s)-level bitmap or identified and/or configured by which region(s) of divided regions (e.g., evenly divided regions) within a BWP (e.g., a currently active BWP and/or CC), for example, which may include an explicit indicator to indicate which region(s) may be applicable for a given usage (e.g., for DL or for UL). As noted above, the WTRU may receive an indication of the RB(s)-level bitmap via a radio resource control (RRC) message that indicates a plurality of UL/DL resource block patterns for one or more symbols. The WTRU may receive an indication via downlink control information (DCI) or a medium access control (MAC) control element (CE) that may indicate which of the plurality of UL/DL resource block patterns indicated in the configuration information is to be applied for the one or more symbols. For example, the indication may indicate that a first UL/DL resource block pattern of the plurality of UL/DL resource block patterns is to be applied for a first symbol of the one or more symbols, and that a second UL/DL resource block pattern of the plurality of UL/DL resource block patterns is to be applied for a second symbol of the one or more symbols.

The second set of RBs for DL usage (e.g., or UL usage) may be defined by the remaining RB(s) within the BWP (e.g., the currently active BWP and/or CC) that are not included in the first set of RBs. The gNB may configure the first set of RBs for UL usage first (e.g., somewhere in the middle within the BWP and not in an edge region, which may result in effectively avoiding inter-operator interference for XDD by the gNB implementation), and the remaining RBs (e.g., including non-contiguous RBs) may be for DL usage.

In examples, the third set of RBs for “Flexible” between DL/UL may be defined by the remaining RB(s) within the BWP (e.g., the currently active BWP and/or CC) that are not included in the first set of RBs and the second set of RBs. The gNB may configure the third set of RBs for “Flexible” between DL/UL, on which DL Rx or UL Tx may be valid (e.g., both may be valid), which may offer scheduling flexibility for the gNB (e.g., and reduce gNB implementation complexity).

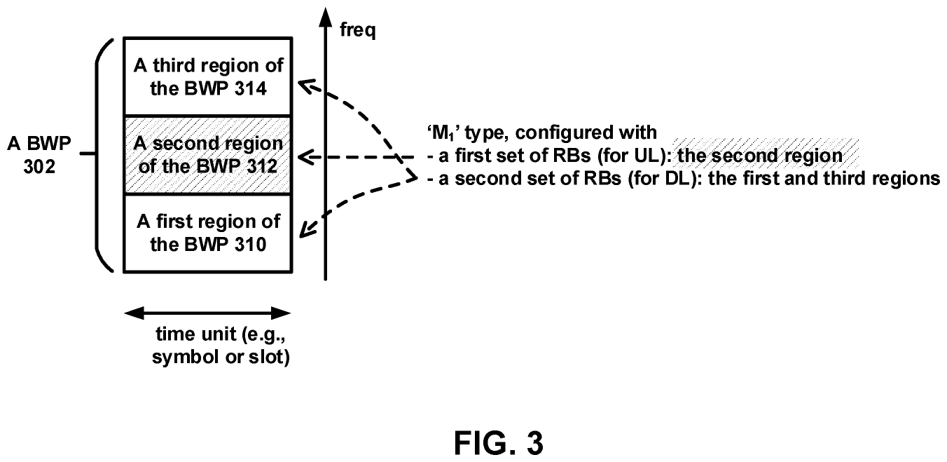

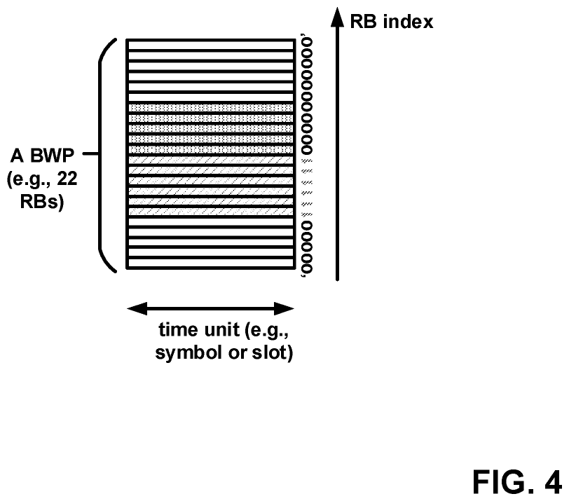

FIG. 3 shows an example of an ‘M₁’ type (e.g., as one of the ‘Mₙ’ type such as for n=1). In examples, the WTRU may be configured (e.g., from the gNB) with one or more of the following types: ‘M₁’ type, ‘M₂’ type, ‘M₃’ type (e.g., depending on gNB configuration), ‘M₄’ type (e.g., depending on gNB configuration), etc. The ‘M₁’ type may include a first set of RBs (e.g., for UL) corresponding to a second region 312 of a BWP 302 and/or a second set of RBs (e.g., for DL) corresponding to a first region 310 and a third region 314 of the BWP 302. FIG. 4 shows an example of an ‘M₂’ type (e.g., as one of the ‘Mₙ’ type such as for n=2). The ‘M₂’ type may comprise a first set of RBs (e.g., for UL) corresponding to a first RB-level bitmap for a BWP (e.g., 0000011111100000000000), a second set of RBs (e.g., for DL) corresponding to a second RB-level bitmap for the BWP (e.g., 1111100000000000111111), and/or a third set of RBs (e.g., for ‘Flexible’) corresponding to the remaining RBs in the BWP other than the first set of RBs and the second set of RBs (e.g., 0000000000011111000000). In examples, the number of ‘Mₙ’ types configurable to a WTRU may be based on related WTRU capability (e.g., capability signaling).

In examples, the WTRU may report its capability on how many ‘Mₙ’ types are configurable and/or supported. The gNB may configure one or more ‘Mₙ’ types based on the reported WTRU capability.

tdd-UL-DL-config, using the ‘Mₙ’ type, may be provided. The WTRU may receive configuration information on a first parameter (e.g., tdd-UL-DL-ConfigurationCommonXDD) and/or a second parameter (e.g., tdd-UL-DL-ConfigurationDedicatedXDD), e.g., by RRC signaling. In examples, the second parameter may indicate (e.g., comprise and/or be associated with) at least one of the one or more ‘Mₙ’ types, ‘D’ type, ‘U’ type, or ‘F’ type, whereas the first parameter may indicate (e.g., comprise and/or be associated with) at least one of ‘D’ type, ‘U’ type, or ‘F’ type. The first parameter may be the same as a legacy parameter of tdd-UL-DL-ConfigurationCommon. Having the same legacy parameter as the first parameter may provide a compatibility in co-existence with legacy WTRUs in terms of a tdd-UL-DL-configuration (e.g., for enabling XDD). Reusing the parameter of tdd-UL-DL-ConfigurationCommon as legacy may protect allocated time-domain resource(s) for DL and allocated time-domain resource(s) for UL, for example, without potential ambiguity of XDD-related signaling having its potential ambiguity period (e.g., on RRC signaling process).

In examples, the first parameter may indicate (e.g., comprise and/or be associated with) at least one of the one or more ‘Mₙ’ types, ‘D’ type, ‘U’ type, or ‘F’ type (e.g., in sub-parameter(s), such as pattern1 and/or pattern2, of the first parameter). In examples, if an ‘Mₙ’ type of the one or more ‘Mₙ’ types is configured, information on a starting symbol position for applying the ‘Mₙ’ type may be indicated (e.g., and/or configured), which may be explicitly configured, or pre-defined/pre-determined (e.g., defined by the next symbol of the last symbol position assigned by a third parameter for the number of (e.g., downlink) symbols/slots (e.g., nrofDownlinkSymbols, nrofDownlinkSlots).

In examples, the second parameter (e.g., tdd-UL-DL-ConfigurationDedicatedXDD) may indicate (e.g., comprise and/or be associated with) at least one of the one or more ‘Mₙ’ types, ‘D’ type, ‘U’ type, or ‘F’ type. In examples, for an indicated slot (e.g., which has at least one symbol corresponding to ‘F’ or ‘Mₙ’ according to the first parameter), the gNB may configure and/or indicate to assign a selective ‘Mₙ’ type (e.g., n=1, or 2, . . . selected by the gNB) by indicator(s) of “allM1symbols”, “allM2symbols”, etc., for the whole remaining symbols corresponding to the ‘F’ (e.g., or ‘Mₙ’), being overridden by the selective ‘Mₙ’ type, within the indicated slot.

In examples, for an indicated slot (e.g., which has at least one symbol corresponding to ‘F’ or ‘Mₙ’ according to the first parameter), the gNB may configure and/or indicate to assign explicit symbol position(s) for a selective ‘Mₙ’ type (e.g., n=1, or 2, . . . selected by the gNB) by indicator(s) of “nrofM1symbols”, “nrofM2symbols”, etc., where a starting symbol position for applying the selective ‘Mₙ’ type may be explicitly configured, or pre-defined/pre-determined (e.g., as the next symbol of nrofDownlinkSymbols). If more than one ‘Mₙ’ type is configured, a second starting symbol position of ‘M₂’ type may be the next symbol (e.g., right next symbol) of the assigned symbol positions for ‘M₁’ type, and so on. For example, the WTRU may receive an indication that indicates that a first UL/DL resource block pattern of a plurality of UL/DL resource block patterns is to be applied for a first symbol of one or more symbols, and that a second UL/DL resource block pattern of the plurality of UL/DL resource block patterns is to be applied for a second symbol of the one or more symbols.

DCI-signaling-based dynamic SFI using the ‘Mₙ’ type may be provided. In examples, a WTRU may receive a DCI comprising an SFI, where the SFI may be pre-determined (e.g., pre-defined or pre-configured) based on at least one of the one or more ‘Mₙ’ types, ‘D’ type, ‘U’ type, or ‘F’ type. For example, the WTRU may receive an indication that each of one or more symbols include both a first subset resource blocks associated with downlink (DL) reception and a second subset of resource blocks associated with uplink (UL) transmission. In examples, a slot-format-combination parameter (e.g., slotFormatCombination) may comprise a slot/symbol-level pattern based on at least one of the one or more ‘Mₙ’ types, ‘D’ type, ‘U’ type, or ‘F’ type, which may be mapped to a codepoint of the SFI of the DCI. The DCI may be received (e.g., only be received) by the WTRU (e.g., as a WTRU-dedicated DCI). The DCI may be received by more than one WTRU in a cell (e.g., as a group-common DCI such as DCI format 2_0).

In examples, at least one of the following may be applied (e.g., or configured and/or indicated to be applied): introducing indicator(s) (e.g., new RRC parameter(s)) for informing an ‘Mₙ’ type(s) for a symbol (e.g., each symbol) marked with ‘F’ in a slot-format-combination parameter (e.g., slotFormatCombination), where the slot-format-combination parameter includes a mapping to a codepoint of an SFI (e.g., in the DCI); and/or introducing new SlotFormat index(es), which may include at least one ‘Mₙ’ type (e.g., using Reserved SlotFormat index(es) such as 56 to 254 or adding new candidates, etc.). For example, introducing new SlotFormat index(es) may include a new index comprising D, D, D, F, F, F, M₁, M₁, M₁, M₂, M₂, M₂, U, and U. For example, introducing new SlotFormat index(es) may include a new index comprising D, M₃, M₃, M₃, F, F, M₁, M₁ M₁, M₂, M₂, M₂, U, and U.

Introducing indicator(s) (e.g., new RRC parameter(s)) for informing an ‘Mₙ’ type(s) for a symbol (e.g., each symbol) marked with ‘F’ in a slot-format-combination parameter (e.g., slotFormatCombination), where the slot-format-combination parameter includes a mapping to a codepoint of an SFI (e.g., in the DCI), may be performed. The whole symbol position(s) marked with ‘F’ in the slot-format-combination parameter may inform (e.g., commonly informed) the WTRU of a selective ‘Mₙ’ type (e.g., n=1, 2, . . . selected by the gNB), for example, by introducing indicator(s) of “allM1forF”, “allM2forF”, etc. For example, the selective ‘Mₙ’ type may be limited within one slot (e.g., comprising 14 symbols), as ‘F’ in a slot-format-combination parameter may be marked per slot. In examples, a special (e.g., or default) value/parameter may be introduced to indicate “no change” of ‘F’ on the symbol position(s) (e.g., not applying ‘Mₙ’ type(s)). In examples, parameter(s) may be introduced for a symbol-wise ‘Mₙ’-type pattern(s) across the symbol position(s) marked with ‘F’ in the slot-format-combination parameter. For example, the pattern may be an alternating pattern of ‘M₁’, ‘M₂’, . . . across the symbol position(s). For example, the pattern may be a pattern in that a first number (e.g., first half) of symbols follow ‘M₁’ type and the rest of the number of symbols follow ‘M₂’ type, etc. For example, one or more patterns/rules may be pre-defined and/or pre-configured and a selector among the one or more patterns/rules may be indicated (e.g., for the slot-format-combination parameter).

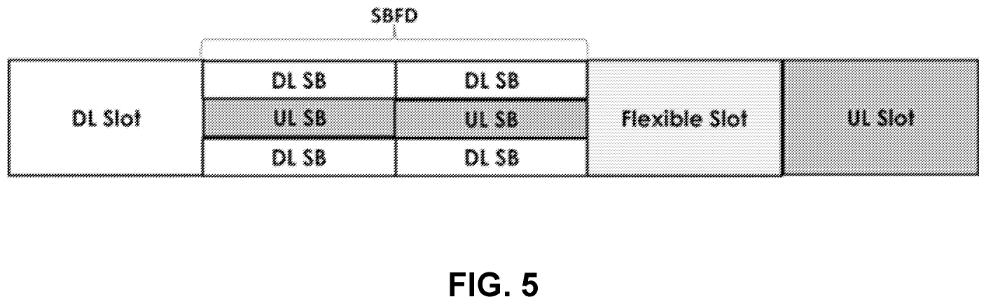

Applicability of NR-duplex operations may be provided. In one or more cases, new radio (NR) duplex operation (e.g., NR-Duplex, XDD, etc.) may be used to improve conventional TDD operation by enhancing UL coverage, improving capacity, reducing latency, and so forth. In one or more cases, a conventional TDD operation may be based on splitting the time domain between the uplink and downlink. Feasibility of allowing full duplex, or more specifically, subband non-overlapping full duplex (SBFD) (e.g., at the gNB) within a conventional TDD band is considered for investigation, e.g., as illustrated in FIG. 5. FIG. 5 illustrates an ‘SBFD slot’, which includes a frequency resource allocation based on a combination of ‘DL SB(s)’ and ‘UL SB(s)’. In some cases, the conventional TDD as illustrated in FIG. 5 may be an example of one or more ‘Mₙ’ types as described herein. In one or more cases, a gNB may schedule UL and DL resources to WTRUs within the UL and DL non-overlapping subbands, respectively.

In one or more cases, operations based on the ‘SBFD slot’ may reduce implementation complexity in FD at least at the gNB. To adapt to changing traffic conditions, having flexibility to change the direction of the sub-bands dynamically may be desirable/beneficial (e.g., at least in terms of gNB's scheduling flexibility, etc.). This, however, may result in cross-link interference (CLI) when configured periodic/semi-persistent resources (e.g., for CSI-RS, PDCCH, CG PUSCH, etc.) to a WTRU overlap with sub-bands switched to the opposite direction. The embodiments provided herein enable dynamic sub-band DL/UL switching without causing CLI for configured resources.

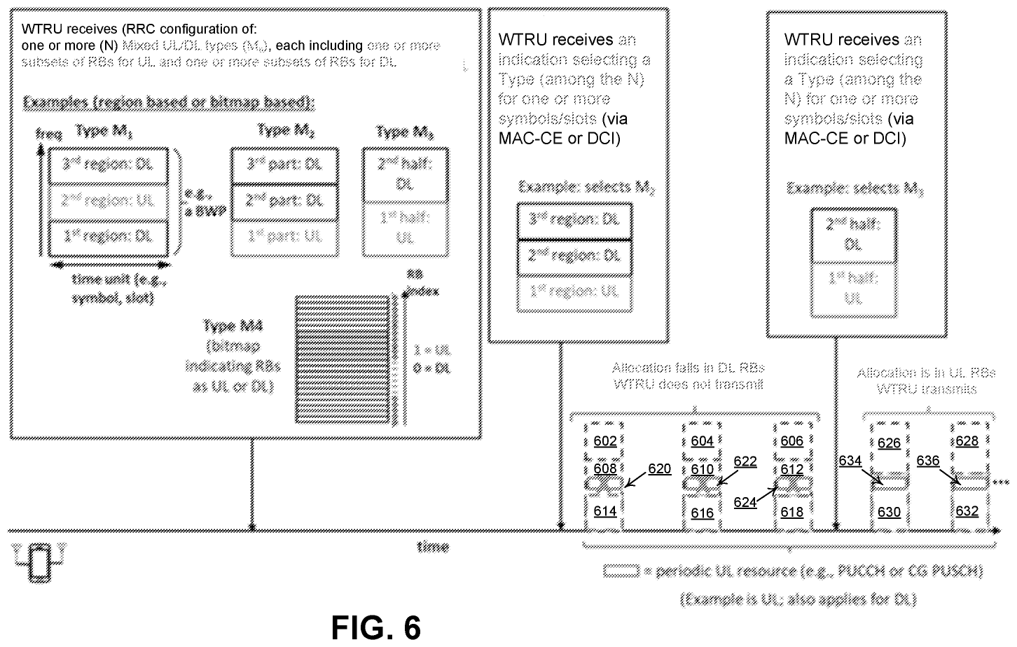

FIG. 6 illustrates examples of SBFD operations based on Mixed UL/DL types (Mₙ). As shown in FIG. 6, for example, the WTRU may receive, e.g., via an RRC signaling, one or more configurations, including (or indicating) one or more (N) Mixed UL/DL types (Mₙ). In one or more cases, the one or more (N) Mixed UL/DL types (Mₙ) may (e.g., each) include one or more subsets of RBs for UL and one or more subsets of RBs for DL. For example, the WTRU may receive an indication that each of one or more symbols include both a first subset resource blocks associated with downlink (DL) reception and a second subset of resource blocks associated with uplink (UL) transmission. Examples of the configurations may include, but are not limited to, ‘region based’ or ‘bitmap based’, etc., based on FIGS. 3, 4, and/or 6 (in which Type M₁, Type M₂, Type M₃, Type M₄ are illustrated as examples).

In one or more cases, the WTRU may be configured to receive an indication selecting a type (among the N) for one or more symbols/slots (e.g., via a MAC-CE and/or a DCI). For example, the WTRU may receive an indication that indicates that a first UL/DL resource block pattern (e.g., Mₙ type) of a plurality of UL/DL resource block patterns is to be applied for a first symbol of one or more symbols. For example, as shown in FIG. 6, the WTRU may receive the indication selecting Type M₂ in which a first frequency region is set as ‘UL’ (SB) (e.g., the frequency regions 614, 616, 618 shown in FIG. 6), a second frequency region (e.g., adjacent to the first frequency region) is set as ‘DL’ (SB) (e.g., the frequency regions 608, 610, 612 shown in FIG. 6), and a third frequency region (e.g., adjacent to the second frequency region) is set as ‘DL’ (SB) (e.g., the frequency regions 602, 604, 606 shown in FIG. 6). The WTRU may be configured with a (periodic) UL resource (e.g., PUCCH, or configured-grant (CG)-PUSCH, etc.) on which a UL signal and/or UL data packet is scheduled to be transmitted (periodically).

In response to receiving the indication selecting Type M₂, the WTRU may determine whether the (periodic) UL resource (e.g., periodic UL resources 620, 622, 624 shown in FIG. 8) is comprised in a ‘UL’ (SB), e.g., the first frequency region (e.g., the frequency regions 614, 616, 618 respectively). In one or more cases, the WTRU may determine that the (periodic) UL resource 620, 622 and/or 624 is not included in the ‘UL’ (SB) frequency region 614, 616, and/or 618, respectively, indicated by the Type M₂. In one or more cases, the WTRU may determine that the allocation of the (periodic) UL resource 620, 622, and/or 624 falls in ‘DL’ (SB or RBs) frequency region 608, 610, and/or 612, respectively, as shown in FIG. 6. In response to determining that the allocation of the UL resource 620, 622, and/or 624 falls in ‘DL’ frequency region 608, 610, and/or 612, respectively, the WTRU may not transmit (e.g., may skip transmitting, may cease transmitting, may drop transmitting, may fail to perform transmission of) the UL resource 620, 622, and/or 624. For example, the WTRU may drop a UL transmission associated with the periodic UL resources 620, 622, and/or 624 in the one or more symbols if the periodic UL resources 620, 622, 624 are comprised in the frequency region(s) 602, 604, 606 and/or the frequency region(s) 608, 61, 612 associated with DL reception for the one or more symbols. In some cases, in response to determining that the allocation of the UL resource falls in ‘DL’, the WTRU may not transmit until being further determined to be valid for transmissions.

In one or more cases, the WTRU may receive a second indication selecting a second type (among the N) for one or more symbols/slots (e.g., via a MAC-CE and/or a DCI). For example, the WTRU may receive an indication that a second UL/DL resource block pattern of the plurality of UL/DL resource block patterns is to be applied for a second symbol of the one or more symbols. For example, the WTRU may receive the second indication selecting Type M₃ in which a first half region (e.g., first half region 630 and/or 632 shown in FIG. 6) is set as ‘UL’ (SB) (e.g., for the cases in which the first half region 630 and/or 632 comprises more RBs compared to the first frequency region 614, 616, and/or 618, respectively (based on Type M₂)), and a second half region (e.g., the second half region 626 and/or 628 shown in FIG. 6) (e.g., adjacent to the first frequency region) is set as ‘DL’ (SB). In one or more cases, the WTRU may determine that the (periodic) UL resource (e.g., the periodic UL resource 634 and/or 636 shown in FIG. 6) is included in the ‘UL’ (SB) first half region 630 and/or 632, respectively, indicated by the Type M₃ (e.g., for the cases in which the allocation of the UL resource 634 and/or 636 is now in ‘UL’ (SB or RBs) first half region 630 and/or 632). In one or more cases, the WTRU may determine that the allocation of the (periodic) UL resource 634 and/or 636 does not fall in ‘DL’ (SB or RBs) second half region 626 and/or 628, as shown in FIG. 6. In response to the determination that UL resource 634 and/or 636 is included in the ‘UL’ (SB) first half region 630 and/or 632, and/or that UL resource does not fall in ‘DL’ second half region 626 and/or 628, the WTRU may transmit (e.g., may continue to transmit, may resume transmitting, etc.) the UL resource 634 and/or 636. For example, the WTRU may transmit a UL transmission associated with periodic UL resources 634 and/or 636 in the one or more symbols if the periodic UL resources 634 and/or 636 are comprised in the region associated with UL transmission (e.g., the first half region 630 and/or 632) for the one or more symbols.

It is noted that these examples are based on a (periodic) UL resource configured/indicated to the WTRU, however, it should be understood that similar examples are also applicable, for example, those based on a (periodic) DL resource configured/indicated to the WTRU. For example, the WTRU may receive a DL transmission associated with one or more periodic DL resources in one or more symbols if the one or more periodic DL resources are comprised in a region associated with DL reception for the one or more symbols. For example, the one or more periodic DL resources may be for one or more of a physical downlink control channel (PDCCH) or a configured grant-physical downlink shared channel (CG-PDSCH). The WTRU may fail to receive a second DL transmission associated with one or more second periodic DL resources in the one or more symbols if the one or more second periodic DL resources are comprised in a region of resource blocks associated with UL reception for the one or more symbols.

In one or more cases, the WTRU may be configured to receive information (e.g., via DCI or MAC CE) indicating that a first subset of resource blocks (RBs) of a plurality of resource blocks associated with one or more symbols are RBs for downlink (DL) reception and that a second subset of RBs of the plurality of RBs associated with the one or more symbols are RBs for uplink (UL) transmission. In one or more cases, the WTRU may receive a DL transmission associated with periodic DL resources (e.g., PDCCH/CG-PDSCH) in the one or more symbols on a condition that the periodic DL resources are included in the first subset of RBs indicated by the information to be RBs for DL reception. In one or more cases, the WTRU may send an UL transmission associated with periodic UL resources (e.g., PUCCH/CG-PUSCH) in the one or more symbols on a condition that the periodic UL resources are included in the second subset of RBs indicated by the information to be RBs for UL reception.

In one or more cases, the WTRU may be further configured to receive configuration information (e.g., via RRC) indicating a plurality of UL/DL RB configurations. In one or more cases, the information (e.g., received via the DCI and/or the MAC-CE) may indicate which of the plurality of UL/DL RB configurations to apply for the one or more symbols. In one or more cases, the WTRU may be configured to drop at least one other UL transmission associated with periodic UL resources (e.g., PUCCH/CG-PUSCH) in the one or more symbols on a condition that the periodic UL resources are included in the first set of RBs indicated by the information to be RBs for DL reception.

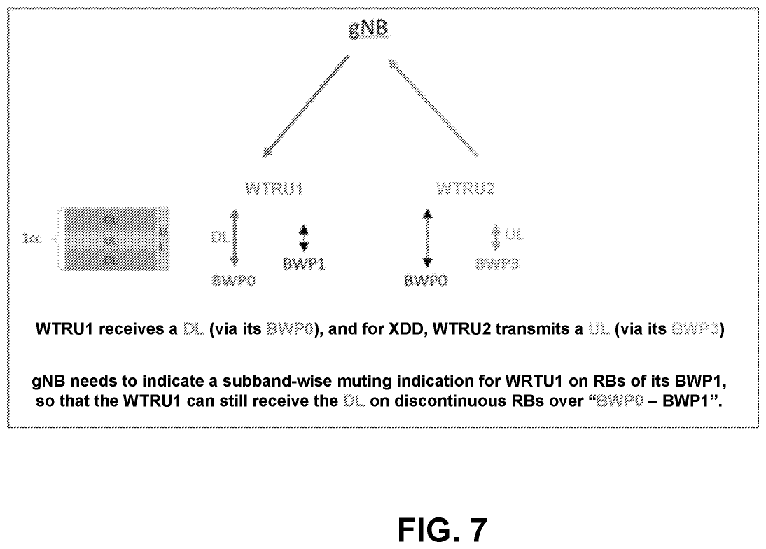

FIG. 7 shows an example of subband-wise (e.g., BWP-wise) dynamic muting for XDD. Indicating subband-level dynamic muting may be provided. In an example where a granularity of the subband for XDD may be a BWP, a BWP-level XDD may be considered as a design for enabling the XDD. A gNB may consider, for a CC, one or more configurable BWPs having one or more planned and/or aligned BWP sizes for multiple WTRUs (e.g., which may support XDD) in a cell. Based on examples described herein, the gNB may be able to dynamically indicate a subband-wise (e.g., BWP-wise) muting command for a WTRU operating on relatively larger RBs as its current active BWP (e.g., BWP0 for WTRU1 as a DL as shown in FIG. 7), e.g., to manage cross-link interference (CLI) in a cell (e.g., WTRU-transparently). Based on examples described herein, similar features (e.g., the gNB may be able to dynamically indicate a subband-wise such as BWP-wise muting command for a WTRU operating on relatively larger UL RBs as its current active UL BWP, etc.) may be applied for uplink implementations.

Introducing a ‘BWP-Muting indicator (BMI)’ as an ON/OFF flag may be provided. In examples, an indicator for reinterpreting a ‘BWP-indicator (BI)’ to indicate RB(s) to be muted for XDD (e.g., instead of indicating a BWP switching/selection as the original purpose of the BI) may be defined and/or configured to be used in a DCI. The indicator (e.g., ‘BWP-Muting indicator (BMI)’) may comprise 1-bit to inform the WTRU of ON or OFF of applying the reinterpretation for the BI.

In examples, the WTRU behavior when receiving a data scheduling DCI (e.g., for DL-DCI format 1_1/1_2) may be defined and/or configured as follows. If the BMI field value is set to a first value (e.g., ‘0’ or BWP-Muting OFF), the WTRU may interpret the DL-DCI as the same as legacy behavior, meaning the BI field works as “BWP switching command” as for its original purpose. If the BMI field value is set to a second value (e.g., ‘1’ or BWP-Muting ON), the WTRU may re-interpret (e.g., newly re-interpret) a value of the BI field as indicating muted DL RBs matched to the BWP corresponding to the value within the current active DL BWP and/or no BWP switching may be performed (e.g., even if the value is toggled). If the BMI field value is set to the second value, the frequency domain resource assignment (FDRA) field in the same DCI may be interpreted as at least one of: existing PDSCH freq-domain resource allocation (e.g., same as legacy and the DCI may schedule the PDSCH according to the current (e.g., unchanged) active DL-BWP) and/or further reduced muted RB indications. For example, a WTRU may receive/detect a DCI (e.g., a DL-DCI, which may be DCI format 1_1) comprising the FDRA field. The DCI may be generally for a DL data (PDSCH) scheduling, where the indicated value by the FDRA field may indicate a frequency-domain resource assignment (e.g., one or more RBs) on which the scheduled data (PDSCH) is transmitted, for reception by the WTRU. For existing PDSCH freq-domain resource allocation, if the scheduled RBs for the PDSCH belong and/or are overlap with the muted DL RBs, the overlapped RB(s) may be considered as rate matched or the WTRU may not expect the overlapping. For further reduced muted RB indications, the WTRU may determine the muted DL RBs by intersecting first RBs matched to the muted BWP (e.g., corresponding to the value of the BI field) and second RBs corresponding to the FDRA field value. In such a case, a PDSCH may not be scheduled with the current DL DCI, and the unused DCI fields in the DCI may be reused for delivering other related information, e.g., which may be applicable to reusing bit widths as described herein.

In examples, the WTRU behavior when receiving a data scheduling DCI (e.g., for DL-DCI format 1_1/1_2) may be defined and/or configured as follows. If the BMI field value is set to the second value, the time domain resource assignment (TDRA) field in the same DCI may indicate the PDSCH receiving time interval and the time duration for applying muted DL RBs (e.g., applied for other DLs other than or including the PDSCH). For example, a WTRU may receive/detect a DCI (e.g., a DL-DCI, which may be DCI format 1_1) comprising the TDRA field. The DCI may be generally for a DL data (PDSCH) scheduling, where the indicated value by the TDRA field may indicate a time-domain resource assignment (e.g., one or more RBs) on which the scheduled data (PDSCH) is transmitted, for reception by the WTRU. In examples, there may be a new and/or separate field indicating the time duration for applying the muted DL RBs. In such a case, there may be a codepoint (e.g., default codepoint) which indicates to apply the same PDSCH receiving time interval as in the same DCI. Other codepoints may be explicitly described by RRC and/or MAC-CE. In examples, if the PDSCH is not scheduled with the DCI (e.g., the FDRA field being reinterpreted to other information content as the further reduced muted RB indication, etc.), the TDRA field may indicate the time duration for applying muted DL RBs. If the BMI field value is set to the second value, when and how long the muted DL RB(s) are applied may be determined and/or configured according to at least one of the following: the muted DL RB(s) may be applied within the time duration of the indicated TDRA field, or within a pre-defined (e.g., the whole current slot), pre-configured, or separately indicated time duration to apply the BWP-muting (e.g., when to apply the BWP-muting may be pre-defined, pre-configured, and/or separately indicated based on WTRU capability) and/or the time duration may be associated with the WTRU's ACK transmission timing (e.g., upon receiving the DCI).

In examples, the WTRU behavior when receiving a data scheduling DCI (e.g., for UL-DCI format 0_1/0_2) may be defined and/or configured as follows. If the BMI field value is set to the first value (e.g., 0 or BWP-Muting OFF), the WTRU may interpret the UL-DCI as the same as legacy behavior, meaning the BI field may work as “BWP switching command” as for its original purpose. If the BMI field value is set to the second value (e.g., 1 or BWP-Muting ON), the WTRU may re-interpret (e.g., newly re-interpret) a value of the BI field as indicating muted UL RBs matched to the BWP corresponding to the value within the current active UL BWP and/or no BWP switching may be performed (e.g., even if the value is toggled). If the BMI field value is set to the second value, the FDRA field in the same DCI may be interpreted as at least one of: existing PUSCH freq-domain resource allocation (e.g., same as legacy) and the DCI may schedule the PUSCH according to the current (e.g., unchanged) active UL-BWP and/or further reduced muted RB indications. For existing PUSCH freq-domain resource allocation, if the scheduled RBs for the PUSCH belongs to and/or overlaps with the muted UL RBs, the overlapped RB(s) may be considered as rate matched or the WTRU may not expect the overlapping. For further reduced muted RB indications, the WTRU may determine the muted UL RBs by intersecting first RBs matched to the muted BWP (e.g., corresponding to the value of the BI field) and second RBs corresponding to the FDRA field value. In such a case, a PUSCH may not be scheduled with the current UL DCI, and the unused DCI fields in the DCI may be reused for delivering other related information, e.g., which may be applicable to reusing bit widths as described herein.

In examples, the WTRU behavior when receiving a data scheduling DCI (e.g., for UL-DCI format 0_1/0_2) may be defined and/or configured as follows. If the BMI field value is set to the second value, the TDRA field in the same DCI may indicate the PUSCH transmitting time interval and/or the time duration for applying muted UL RBs (e.g., applied for (other) ULs other than (e.g., or including) the PUSCH). In examples, there may be a new and/or separate field indicating the time duration for applying the muted UL RBs. In such a case, there may be a codepoint (e.g., default codepoint) which indicates to apply the same PUSCH transmitting time interval as in the same DCI. Other codepoints may be explicitly described by RRC and/or MAC-CE. In examples, if the PUSCH is not scheduled with the DCI (e.g., the FDRA field being reinterpreted to other information content as the further reduced muted RB indication, etc.), the TDRA field may indicate the time duration for applying muted UL RBs. If the BMI field value is set to the second value, when and how long the muted UL RB(s) are applied may be determined and/or configured according to at least one of the following: the muted UL RB(s) may be applied within the time duration of the indicated TDRA field, or within a pre-defined (e.g., the whole current slot), pre-configured, or separately indicated time duration to apply the BWP-muting (e.g., when to apply the BWP-muting may be pre-defined, pre-configured, and/or separately indicated based on WTRU capability) and/or the time duration may be associated with the WTRU's UL transmission timing (e.g., upon receiving the DCI), for example, where the UL transmission timing may be the PUSCH transmission timing which may be regarded as delivering ACK upon receiving the DCI.

Support of an implicit BMI indication may be provided. In examples, an indicator (e.g., the BMI) for reinterpreting an existing BI field to indicate RB(s) to be muted for XDD may be implicitly informed to the WTRU, based on at least one of the following: by a combination of “hard-coded” bit field(s) (e.g., to inform the WTRU that the DCI is not scheduling data such as PDSCH and/or PUSCH), depending on an indicated value of the ‘BWP-indicator’ (BI) being toggled or not (e.g., combined with applying the combination of “hard-coded” bit field(s), or by a new pre-defined/pre-configured RNTI for the BWP-Muting purpose (e.g., Muting-RNTI (M-RNTI) may be used for detecting a DCI). In examples, the “hard-coded” bit field may be an FDRA field set to all a first value (e.g., 0) or a second value (e.g., 1)′ For example, the field may be set to all ‘0’s in a configuration case of FDRA Type 0, all ‘1’s in a configuration case of FDRA Type 1, or all ‘0’s in a configuration case of dynamicSwitch. In examples, a redundancy version (RV) may be set to all ‘1’s, a modulation and coding scheme (MCS) may be set to all ‘1’s, and/or a new data indicator (NDI) may be set to 0, etc.

In examples, an indicator (e.g., the BMI) for reinterpreting an existing BI field to indicate RB(s) to be muted for XDD may be implicitly informed to the WTRU, based on whether an indicated value of the ‘BWP-indicator’ (BI) is toggled (e.g., combined with applying the combination of “hard-coded” bit field(s). If the value of BI is not toggled (e.g., indicated with the same value as the current BWP index), the WTRU may consider that the DCI is not for the dynamic BWP-Muting command (e.g., instead the DCI is for other purposes such as an existing SCell dormancy indication, or for other purpose of DCI indication). If the value of BI is toggled (e.g., indicated with a different value from the current BWP index), the WTRU may consider that the DCI is for the dynamic BWP-Muting command (e.g., for XDD operations) and the WTRU may apply the BWP-muting on RBs corresponding to the ‘toggled value of the BI field’ within the time duration of the indicated TDRA field or within a pre-defined, pre-configured, or separately indicated time duration to apply the BWP-muting. When to apply the BWP-muting may be pre-defined, pre-configured, or separately indicated (e.g., based on WTRU capability). The time duration may be associated with the WTRU's ACK transmission timing (e.g., based on receiving the DCI). An operation by the dynamic BWP-Muting command may be maintaining (e.g., not switching) the current active BWP and indicating (e.g., only indicating) another BWP freq-region to be muted for XDD operations (e.g., as shown in FIG. 7). Applying the dynamic BWP-muting only if the BI is toggled may offer efficient control signaling mechanism without increasing signaling overhead.

Support of re-interpreting other field(s) in a DCI may be provided. In examples, based on at least one condition described herein being met (e.g., if a DCI is determined to be not scheduling data, due to the reinterpretation and/or according to the “hard-coded” bit field, etc.), other field(s) in the DCI may be re-interpreted (e.g., reused) for delivering more information contents for other purpose (e.g., related to XDD operations). At least one of the following may apply. For a DL-DCI, by reusing bit widths of at least one of MCS, NDI, RV, HARQ process number, antenna port(s), DMRS sequence initialization, TCI, identifier for DCI formats, carrier indicator, TDRA, DAI, TPC, PRB bundling, PRI, PDSCH-to-HARQ_feedback timing indicator (e.g., if present), more information contents (e.g., related to XDD operations) may be provided with at least one of: the applicable time instance of the muting command, the applicable time duration of the muting command, any specific exception(s) for the muting, and/or any multiple-CCs simultaneous indication (e.g., with the same indicated and/or toggled BWP-index, or separately enumerated BWP-index(es) to be muted per CC). Any specific exception(s) for the muting may include SSB (e.g., which may be by default an exception), SS (e.g., CSS only, or some listed SS(s) by RRC and/or MAC-CE), CORESET (e.g., CORESET #0 only, or some listed SS(s) by RRC and/or MAC-CE), CSI-RS (e.g., CSI-RS for mobility only, or some listed CSI-RS(s) by RRC and/or MAC-CE), and/or some periodic/semi-persistent CSI-RS(s), and/or an indication for UL power control adjustment, e.g., on whether to apply UL PC adjustment behavior(s) (due to XDD operations), etc. configurable by gNB.

In examples, based on at least one condition described herein being met (e.g., if a DCI is determined to be not scheduling data, due to the reinterpretation and/or according to the “hard-coded” bit field, etc.), other field(s) in the DCI may be re-interpreted (e.g., reused) for delivering more information contents for other purpose (e.g., related to XDD operations). At least one of the following may apply. For a UL-DCI, by reusing bit widths of at least one of MCS, NDI, RV, HARQ process number, antenna port(s), DMRS sequence initialization, SRI, precoding information and number of layers, PTRS-DMRS association, identifier for DCI formats, carrier indicator, TDRA, DAI, more information (e.g., related to XDD operations) may be provided at least one of the following. The information may be the applicable time instance of the muting command, the applicable time duration of the muting command, or any specific exception(s) for the muting. In examples, the specific exception(s) for the muting may include RACH (e.g., which may be by default an exception), PUCCH (e.g., listed PUCCH resource(s) by RRC and/or MAC-CE), SRS (e.g., listed SRS(s) by RRC and/or MAC-CE), and/or some periodic/semi-persistent SRS(s), an indication for UL power control adjustment, e.g., on whether to apply UL PC adjustment behavior(s) (e.g., due to XDD operations), etc. (e.g., configurable by gNB). The information may be any multiple-CCs simultaneous indication (e.g., with the same indicated/toggled BWP-index, or separately enumerated BWP-index to be muted per CC). In examples, the other field(s) may remain no use (e.g., fields values are ignored).

Enhancements on INT-indicating DCI may be provided.

DCI format 2_1 may be used for notifying the PRB(s) and OFDM symbol(s), for example, where the WTRU may assume no transmission is intended for the WTRU. The following information may be transmitted by means of the DCI format 2_1 with CRC scrambled by INT-RNTI: pre-emption indication 1, pre-emption indication 2, . . . , pre-emption indication N. The size of the DCI format 2_1 may be configurable by higher layer signaling (e.g., up to 126 bits). A pre-emption indication (e.g., each pre-emption indication) may be C bits (e.g., C=14).

An Interrupted Transmission Indication (INT)-indicating DCI (e.g., format 2_1) may be enhanced to deliver RB(s) to be muted for XDD operations. One or more of the following may apply. The WTRU may be configured with an RRC parameter enabling the XDD. A DCI, for example the existing INT-indicating DCI (e.g., DCI format 2_1) may comprise a field (e.g., new field) of ‘Muted BWP indication’ (MBI). Time-domain indications (e.g., based on the legacy INT operation by DCI format 2_1) may be provided/interpreted for when and/or how long the muted DL RBs for XDD are applied.

In the case of a DCI, for example the existing INT-indicating DCI (e.g., DCI format 2_1), that comprises the MBI field one or more of the following may apply. The MBI field may have the same field values as the BI field (e.g., value ‘00’ for BWP0, value ‘01’ for BWP1, value ‘10’ for BWP2, value ‘11’ for BWP3, and may indicate a BWP to be muted such as not to be switched/selected). The MBI field (e.g., 2-bit) may have an independent functionality from the BMI field (e.g., 1-bit) as a ON/OFF flag for reinterpretation as described herein. A single MBI field may be inserted in the DCI 2_1. Multiple MBI fields may be inserted in the DCI 2_1, e.g., by one-to-one mapping with existing parameters of ‘Pre-emption indication n (for 1, . . . , N)’.

In the case where the single MBI field may be inserted in the DCI field 2_1, one or more of the following may apply. The BWP-level dynamic muting indication may apply (e.g., only apply) for the same CC where the DCI 2_1 is received. A value of the MBI field may indicate the muted DL RBs (e.g., for XDD) matched to the BWP corresponding to the value (e.g., without changing the current active DL BWP) of the same CC. This may have a restriction that the dynamic muting indication for XDD is applicable (e.g., only applicable) for one CC (e.g., and the one CC does not apply the same legacy INT indication in terms of freq-domain). In examples, the single value of the MBI field may be applicable for CCs (e.g., all CCs which may be indicated by corresponding ‘Pre-emption indication n (for 1, . . . , N)’). The mode of operation may be pre-configured by RRC (e.g., as a mode selection for XDD). Other CC(s), e.g., indicated by ‘Pre-emption indication n (for 1, . . . , N)’, may work as the same legacy INT indications (e.g., to interrupt whole RBs of the active DL BWP for each CC).

In the case where multiple MBI fields may be inserted in the DCI 2_1, e.g., by one-to-one mapping with existing parameters of ‘Pre-emption indication n (for 1, . . . , N)’, one or more of the following may apply. In examples, MBI 1, MBI 2, . . . , MBI N may be provided. MBI 1 may correspond to ‘Pre-emption indication 1’, MBI 2 may correspond to ‘Pre-emption indication 2’, . . . . MBI N may correspond to ‘Pre-emption indication N’. A BWP-level dynamic muting indication (e.g., each BWP-level dynamic muting indication) may apply for each CC (e.g., indicated by corresponding ‘Pre-emption indication n’). A value of the MBI field for a CC may indicate the muted DL RBs (e.g., for XDD) matched to the BWP corresponding to the value (e.g., without changing the current active DL BWP) of the CC. There may be a restriction for the operation that the value may be toggled (e.g., as different from a current active BWP for the CC). The dynamic muting indication for XDD may be applicable simultaneously for multiple CCs. Other CC(s), e.g., indicated by ‘Pre-emption indication n (for 1, . . . , N)’ (e.g., and a value of the MBI n is not toggled), may work as the same legacy INT indications (e.g., to interrupt whole RBs of the active DL BWP for each CC).

In the case where time-domain indications for when and/or how long the muted DL RBs for XDD are applied, one or more of the following may apply. For CC(s) where muted DL RBs for XDD are applied, when and how long the muted DL RBs are valid may follow the legacy INT indications in the same DCI format 2_1 in terms of time-domain. For other CC(s), e.g., indicated by ‘Pre-emption indication n (for 1, . . . , N)’ (e.g., not applying the muted DL RBs for XDD), when and how long the DL preemption is valid may follow the legacy INT indications in the same DCI format 2_1 in terms of time-domain.

A DCI format, for example a new DCI format (e.g., format 2_1A), having a separated function (e.g., purpose) from the existing INT-indicating DCI (e.g., format 2_1) may be introduced to deliver RB(s) to be muted, e.g., for XDD operations. One or more of the following may apply. The WTRU may be configured with a RRC parameter enabling the XDD. The WTRU may be configured with an RNTI, for example a new RNTI (e.g., M-RNTI) for the operation. A DCI format, for example new DCI format (e.g., 2_1A), may have a field (e.g., new field) of ‘Muted BWP indication’ (MBI). Time-domain indications (e.g., based on the legacy INT operation by DCI format 2_1) for when and how long the muted DL RBs for XDD may be applied.

In the case where a DCI format, for example a new DCI format (e.g., 2_1A), may have a field of ‘Muted BWP indication’ (MBI), one or more of the following may apply. A single MBI field may be inserted in the DCI 2_1A. Multiple MBI fields may be inserted in the DCI 2_1A, e.g., by one-to-one mapping with parameters of ‘Pre-emption indication n (for 1, . . . , N)’.

In the case where a single MBI field is inserted in the DCI 2_1A, one or more of the following may apply. The BWP-level dynamic muting indication may apply (e.g., only apply) for the same CC where the DCI 2_1A is received. A value of the MBI field may indicate the muted DL RBs (e.g., for XDD) matched to the BWP corresponding to the value (e.g., without changing the current active DL BWP) of the same CC. In examples, the BWP-level dynamic muting indication may apply (e.g., only apply) for a CC indicated by corresponding ‘Pre-emption indication n’. A value of the MBI field may indicate the muted DL RBs (e.g., for XDD) matched to the BWP corresponding to the value within the current active DL BWP of the CC. In examples, the single value of the MBI field may be applicable for CCs (e.g., all CCs indicated by corresponding ‘Pre-emption indication n (for 1, . . . , N)’). The mode of operation may be pre-configured by RRC (e.g., as a mode selection for XDD).

In the case where multiple MBI fields are inserted in the DCI 2_1A, e.g., by one-to-one mapping with parameters of ‘Pre-emption indication n (for 1, . . . , N)’, one or more of the following may apply. MBI 1, MBI 2, . . . , MBI N may be provided. MBI 1 may correspond to ‘Pre-emption indication 1’, MBI 2 may correspond to ‘Pre-emption indication 2’, . . . . MBI N may correspond to ‘Pre-emption indication N’. A BWP-level dynamic muting indication (e.g., each BWP-level dynamic muting indication) may apply for each CC (e.g., indicated by corresponding ‘Pre-emption indication n’). A value of the MBI field for a CC may indicate the muted DL RBs (e.g., for XDD) matched to the BWP corresponding to the value (e.g., without changing the current active DL BWP) of the CC. There may be a restriction for the operation that the value may be toggled (e.g., as different from a current active BWP for the CC). The dynamic muting indication for XDD may be applicable simultaneously for multiple CCs.

In the case where there are time-domain indications for when and/or how long the muted DL RBs for XDD are applied, one or more of the following may apply. For CC(s) where muted DL RBs for XDD are applied, when and how long the muted DL RBs are valid may follow the legacy INT indications in the same DCI format 2_1A in terms of time-domain.

Explicit signaling/indication (e.g., via a MAC-CE and/or a DCI) of a muted BWP for XDD may be provided. In examples, a separate explicit signaling/indication (e.g., via a MAC-CE and/or a DCI) of a muted BWP for XDD (e.g., independently for DL or UL, or simultaneously for both DL/UL, or differently paired information for DL/UL in a same MAC-CE, etc.) may be applied and informed to the WTRU. One or more of the following may apply. One or more Muted BWP Indications (MBIs) may be included in a MAC-CE and/or a DCI message. Time-domain indications may be included on when and how long the muted DL (e.g., or UL) RBs for XDD are applied. The WTRU's ACK message may be sent, for example, after successful decoding of the MAC-CE. The WTRU may receive the explicit indication MAC CE with a specific logical channel ID (LCID) for the explicit signaling. The WTRU may receive the explicit indication DCI scrambled by a specific RNTI for the explicit signaling.

In the case where one or more muted BWP Indications (MBIs) are included in a MAC-CE and/or a DCI message, one or more of the following may apply. The one or more indications (e.g., each of the one or more indications) may be associated/indicated with a corresponding CC index (e.g., in the same MAC-CE and/or the same DCI message). An MBI (e.g., each MBI) may apply for each CC (e.g., indicated by corresponding CC-index). A value of the MBI for a CC may indicate the muted DL RBs (e.g., for XDD) matched to the BWP corresponding to the value, for example, within (e.g., but without changing) the current active DL (e.g., or UL) BWP of the CC. In examples, there may be a restriction for the operation that the value may be a different value from a current active BWP for the CC. The WTRU may receive the DCI message by receiving a WTRU-specific DCI format. The WTRU may receive the DCI message by receiving a group DCI format. For example, the WTRU may receive one or more MBIs in the DCI message. The WTRU may identify a MBI of the one or more MBIs based on a group ID of the WTRU. The WTRU may receive the group ID based on one or more of RRC, MAC CE, and DCI.

In the case where the WTRU's ACK message are sent after decoding (e.g., successful decoding) of the MAC-CE, the “Time-domain indications” may be interpreted, for example, depending on the ACK transmission timing.

In the case where the WTRU receives the explicit indication MAC CE with a specific logical channel ID (LCID) for the explicit signaling, the WTRU may use a predefined LCID for the reception. In examples, the WTRU may receive the specific LCID based on one or more of RRC and MAC CE.

In the case where the WTRU receives the explicit indication DCI scrambled by a specific RNTI for the explicit signaling, the WTRU may use a predefined RNTI for the reception. In examples, the WTRU may receive the specific RNTI based on one or more of RRC and MAC CE.

Dynamic RB-level Muting Indication (RBMI) may be provided. In examples, dynamic RB-level Muting Indication (RBMI), e.g., within a BWP, may be applied and informed to the WTRU, e.g., for XDD operations. One or more of the following may apply. In examples, a gNB may configure a different number of RBs being mapped to a value of RBMI (e.g., each value of RBMI). In examples, indication by the RBMI may be interpreted by reusing an existing FDRA field (e.g., when applicable). In examples, at least one codepoint of a RBMI field may be linked to the existing “reserved resources” indications (e.g., rateMatchPatternGroup1 and/or rateMatchPatternGroup2). In examples, an RBMI field may share the same existing field of ‘Rate matching indicator’ (e.g., and gNB may configure a RRC enabler (e.g., for XDD) to re-interpret that the ‘Rate matching indicator’ is applicable for PDSCH and to be applied for other DLs (e.g., except SSB)). In examples, indication by the RBMI may be given separately/explicitly.

In the case where the RBMI field shares the same existing field of ‘Rate matching indicator’ (e.g., and gNB may configure an RRC enabler (e.g., for XDD) to re-interpret that the ‘Rate matching indicator’ is applicable for PDSCH and to be applied for other DLs (e.g., except SSB), one or more of the following may apply. This may apply for a DL DCI, as a UL-DCI may not comprise a ‘Rate matching indicator’.

Collision handling between muted BWP and active BWP may be provided. In examples, a WTRU may receive one or more indications for one or more muted BWPs and one or more active BWPs. The indications may be based on one or more of BI, BMI, MBI, and/or RBMI. Based on the indications, time and/or frequency resources of the one or more muted BWPs may overlap (e.g., collide) with time and/or frequency resources of the one or more active BWPs. Based on the overlap, the WTRU may perform one or more of following: assume overlapped time/frequency resources as muted BWPs, assume overlapped time/frequency resources as active BWPs, and/or determine based on one or more conditions.

The WTRU may assume the overlapped time/frequency resources as muted BWPs. For example, if one or more muted BWPs fully/partially overlaps with one or more active BWPs, the WTRU may assume the overlapped time/frequency resource are muted BWPs.

The WTRU may assume the overlapped time/frequency resources as muted BWPs. For example, if one or more muted BWPs fully/partially overlaps with one or more active BWPs, the WTRU may assume the overlapped time/frequency resource as active BWPs.

The WTRU may determine whether to determine the overlapped time/frequency resources as muted BWPs or active BWPs based on one or more conditions. For example, if the one or more conditions are satisfied, the WTRU may determine the overlapped time/frequency resources as muted BWPs. If the one or more conditions are not satisfied, the WTRU may determine the overlapped time/frequency resources as active BWPs. The one or more conditions may be one or more of following: priority indicator, DCI format, size of time/frequency resources, number of subbands, and/or an SMTC window.

The WTRU may determine whether to determine the overlapped time/frequency resources as muted BWPs or active BWPs based on a priority indicator. For example, if the WTRU receives the muted BWP with higher priority (e.g., based on a priority indicator in DCI), the WTRU may assume the overlapped time/frequency resources as muted BWP. If the WTRU receives the active BWP with higher priority (e.g., based on a priority indicator in DCI), the WTRU may assume the overlapped time/frequency resources as active BWP. For example, if the WTRU receives PDSCH/PUSCH scheduling with higher priority in the overlapped time/frequency resources, the WTRU may assume the overlapped time/frequency resources as active BWP. If the WTRU receives PDSCH/PUSCH scheduling with lower priority (e.g., based on a priority indicator in DCI), the WTRU may assume the overlapped time/frequency resources as muted BWP.

The WTRU may determine whether to determine the overlapped time/frequency resources as muted BWPs or active BWPs based on an indicated DCI format (e.g., WTRU-specific DCI such as DCI formats 0_1, 0_2, 1_1, or 1_2_ or group DCI such as DCI format 2_x). For example, if the WTRU receives the muted BWP via a first DCI format (e.g., DCI format 2_x), the WTRU may assume the overlapped time/frequency resources as muted BWP. If the WTRU receives the active BWP via a second DCI format (e.g., DCI formats 0_1, 0_2, 1_1, or 1_2), the WTRU may assume the overlapped time/frequency resources as active BWP.

The WTRU may determine whether to determine the overlapped time/frequency resources as muted BWPs or active BWPs based on one or more SMTC windows. For example, if the overlapped time/frequency resources include one or more SMTC windows, the WTRU may assume the overlapped time/frequency resources as active BWPs. Otherwise, the UE may assume the overlapped time/frequency resources as muted BWPs.

Behaviors based on the ‘Mₙ’ type(s) and/or muted RB(s) may be provided. In examples, based on at least one condition described herein being met (e.g., for a symbol/slot, such as if the symbol/slot corresponds to, belongs to, is associated with, or is configured/indicated by an ‘Mₙ’ type), one or more of the following may apply (e.g., for a full-duplex (FD) supported WTRU). If a WTRU determines the symbol (e.g., slot) corresponds to an ‘Mₙ’ type comprising a first set of RBs for UL and a second set of RBs for DL (e.g., and if the WTRU reports its capability supporting a full-duplex (FD) operation at the WTRU and/or the UE receives (e.g., from the gNB) a message/signaling/indication to confirm/configure the FD operation at the WTRU), one or more of the following may apply. If the WTRU determines the symbol (e.g., slot) corresponds to an ‘Mₙ’ type comprising the first set of RBs for UL and the second set of RBs for DL, the WTRU may determine that the first set of RBs are valid as UL for scheduled/configured UL transmissions (e.g., PUCCH, PUSCH, CG-PUSCH, UL-RS, etc.), and the WTRU may perform the UL Tx on the first set of RBs. If the WTRU determines the symbol (e.g., slot) corresponds to an ‘Mₙ’ type comprising the first set of RBs for UL and the second set of RBs for DL, the WTRU may determine that the second set of RBs are valid as DL for scheduled/configured DL receptions (e.g., PDSCH, PDCCH, RS measurements), and the WTRU may perform the DL Rx on the second set of RBs (e.g., simultaneously with the UL Tx on the same symbol such as the FD operation at the WTRU).

In the case where the WTRU determines that the first set of RBs are valid as UL for scheduled/configured UL transmission (e.g., PUCCH, PUSCH, CG-PUSCH, UL-RS, etc.) and the WTRU may perform the UL Tx on the first set of RBs, one or more of the following may apply. Transmission (e.g., any transmission) of a UL resource (e.g., scheduled, configured, or indicated to transmit such as PUCCH, PUSCH, CG-PUSCH, UL-RS, etc.), if not fully allocated (e.g., if less than X₁ RB(s) are allocated) on the first set of RBs, may be cancelled/skipped on the symbol (e.g., and other associated symbol(s) for the UL resource). The cancelling/skipping condition may be pre-defined/pre-configured/indicated. The cancelling/skipping condition may be pre-defined/pre-configured/indicated per particular channel(s)/signal(s) (e.g., per at least one among PUCCH, PUSCH, SRS, and/or PRACH, etc). In examples, the cancelling/skipping condition may be based on determining a ratio R₁ of a first number of RB(s) for the UL resource being fully overlapped with the first set of RBs to a second number of RB(s) for the UL resource being not overlapped with the first set of RBs. If the ratio R₁ is less than a threshold (e.g., R_{UL}), transmission of the UL resource may be cancelled/skipped on the symbol (e.g., and other associated symbol(s) for the UL resource).

In examples, the cancelling/skipping condition may be based on checking whether one or more (e.g., all) symbols (e.g., or D₁ symbols) for transmission of the UL resource (e.g., for slot(s)/symbol(s)) are satisfied with at least one condition(s) described herein. If satisfied, the UL resource may be transmitted. If not all symbols (e.g., or D₁ symbols) are satisfied, transmission of the UL may be cancelled/skipped for a corresponding transmit occasion (e.g., for slot(s)/symbol(s)). In examples, the cancelling/skipping condition may be determined/defined/configured (e.g., independently determined/defined/configured) based on whether the UL resource is scheduled by a DCI (e.g., a dynamic scheduling and/or grant case) or by higher-layer signaling (e.g., a semi-static scheduling case, configured-grant case, etc.). The cancelling/skipping may mean that, in other transmission occasion(s) of the UL resource, transmission of the UL resource may be performed by the WTRU (e.g., depending on a condition for each transmission occasion and/or if the UL resource is periodic or semi-persistent). If (e.g., at least one RB or) at least X₂ RBs among the first set of RBs are determined/identified as overlapped with a DL resource (e.g., scheduled, configured, or indicated to measure/monitor such as PDCCH, PDSCH, SPS-PDSCH, DL-RS, etc.), reception of the DL resource may be cancelled/skipped at least on the symbol (e.g., and other associated symbol(s) for the DL resource). The cancelling/skipping may mean that, in other reception occasion(s) of the DL resource, reception of the DL resource may be performed by the WTRU (e.g., depending on a condition for each reception occasion and/or if the DL resource is periodic or semi-persistent). X₁, R_{UL}, D₁, and/or X₂ may be configured, pre-defined, or indicated.

In the case where the WTRU determines that the second set of RBs are valid as DL for scheduled/configured DL receptions (e.g., PDSCH, PDCCH, RS measurements), and the WTRU may perform the DL Rx on the second set of RBs (e.g., simultaneously with the UL Tx on the same symbol as the FD operating at the WTRU), one or more of the following may apply. Reception (e.g., any reception) of a DL resource (e.g., scheduled, configured, or indicated to measure/monitor such as PDCCH, PDSCH, SPS-PDSCH, DL-RS, etc.), if not fully allocated (e.g., if less than Y₁ RB(s) are allocated) on the second set of RBs, may be cancelled/skipped on the symbol (e.g., and other associated symbol(s) for the DL resource). The cancelling/skipping condition may be pre-defined/pre-configured/indicated. The cancelling/skipping condition may be pre-defined/pre-configured/indicated per particular channel(s)/signal(s) (e.g., per at least one among PDCCH such as CORESET and/or search space, PDSCH, and/or CSI-RS, etc.). In examples, the cancelling/skipping condition may be based on determining a ratio R₂ of a first number of RB(s) for the DL resource being fully overlapped with the second set of RBs to a second number of RB(s) for the DL resource being not overlapped with the second set of RBs. If the ratio R₂ is less than a threshold R_{DL}, reception of the DL resource may be cancelled/skipped on the symbol (e.g., and other associated symbol(s) for the DL resource). In examples, the cancelling/skipping condition may be based on checking whether all symbols (e.g., or D₂ symbols) for reception of the DL resource (e.g., for slot(s)/symbol(s)) are satisfied with at least one condition(s) described herein. If satisfied, the DL resource may be received. If not all symbols (e.g., or D₂ symbols) are satisfied, reception of the DL may be cancelled/skipped for a corresponding reception occasion (e.g., for a slot(s)/symbol(s). In examples, cancelling/skipping condition may be determined/defined/configured (e.g., independently determined/defined/configured) based on whether the DL resource is scheduled by a DCI (e.g., a dynamic scheduling and/or grant case) or by a higher-layer signaling (e.g., a semi-static scheduling case, configured-grant case, etc.). The cancelling/skipping may mean that, in other reception occasion(s) of the DL resource, reception of the DL resource may be performed by the WTRU (e.g., depending on a condition for each reception occasion and/or if the DL resource is periodic or semi-persistent). If (e.g., at least one RB or) at least Y₂ RBs among the second set of RBs are determined/identified as overlapped with a UL resource (e.g., scheduled, configured, or indicated to transmit), transmission of the UL resource may be cancelled/skipped at least on the symbol (e.g., and other associated symbol(s) for the UL resource). The cancelling/skipping may mean that, in other reception occasion(s) of the UL resource, transmission of the UL resource may be performed by the WTRU (e.g., depending on a condition for each transmission occasion and/or if the UL resource is periodic or semi-persistent). Y₁, R_{DL}, D₂, and/or Y₂ may be configured, pre-defined, or indicated.

In examples, based on at least one condition described herein being met (e.g., for a symbol/slot, such as if the symbol/slot corresponds to, belongs to, is associated with, and/or is configured/indicated by an ‘Mₙ’ type), one or more of the following may apply (e.g., for a half-duplex (HD) supported WTRU). If a WTRU determines the symbol (e.g., slot) corresponds to a ‘Mₙ’ type comprising a first set of RBs for UL and a second set of RBs for DL (e.g., and if the WTRU reports its capability supporting a half-duplex (HD) operation at the WTRU and/or the WTRU receives from the gNB a message/signaling/indication to confirm/configure the HD operation at the WTRU), one or more of the following may apply. If the WTRU determines the symbol (e.g., slot) corresponds to an ‘Mₙ’ type comprising the first set of RBs for UL and the second set of RBs for DL, the WTRU may determine that the first set of RBs are valid as UL for scheduled/configured UL transmissions (e.g., PUCCH, PUSCH, CG-PUSCH, UL-RS, etc.), and the WTRU may perform the UL Tx on the first set of RBs, for example, if the WTRU identifies/determines that the symbol (e.g., slot) is used for ‘UL’ (e.g., and not for ‘DL’, without mixing UL and DL in the same symbol/slot). Otherwise (e.g., if the WTRU identifies/determines that the symbol/slot is used for ‘DL’), the UL transmission(s) (e.g., transmission of a UL resource) may be cancelled/skipped on the symbol (e.g., slot). If the WTRU determines the symbol (e.g., slot) corresponds to an ‘Mₙ’ type comprising the first set of RBs for UL and the second set of RBs for DL, the WTRU may determine that the second set of RBs are valid as DL for scheduled/configured DL receptions (e.g., PDCCH, PDSCH, SPS-PDSCH, and/or RS measurements), and the WTRU may perform the DL Rx on the first set of RBs, for example, if the UE identifies/determines that the symbol (e.g., slot) is used for ‘DL’ (e.g., and not for ‘UL’, without mixing UL and DL in the same symbol/slot). Otherwise, (e.g., if the WTRU identifies/determines that the symbol/slot is used for ‘UL’), the DL reception(s) (e.g., reception of a DL resource) may be cancelled/skipped on the symbol (e.g., slot).

In the case where the WTRU determines that the first set of RBs are valid as UL for scheduled/configured UL transmissions (e.g., PUCCH, PUSCH, CG-PUSCH, UL-RS, etc.), and the WTRU may perform the UL Tx on the first set of RBs, for example, if the WTRU identifies/determines that the symbol (e.g., slot) is used for ‘UL’ (e.g., and not for ‘DL’, without mixing UL and DL in the same symbol (/slot) and otherwise, (e.g., if the WTRU identifies/determines that the symbol (e.g., slot) is used for ‘DL’), the UL transmission(s) (e.g., transmission of a UL resource) may be cancelled/skipped on the symbol (/slot), one or more of the following may apply. The cancelling/skipping may mean that, in other transmission occasion(s) of the UL resource, transmission of the UL resource may be performed by the WTRU (e.g., depending on a condition for each transmission occasion and/or if the UL resource is periodic or semi-persistent).

The WTRU may identify/determine that the symbol (e.g., slot) is used for ‘UL’. Transmission (e.g., any transmission) of a UL resource (e.g., scheduled, configured, or indicated to transmit such as PUCCH, PUSCH, CG-PUSCH, UL-RS, etc.), if not fully allocated (e.g., if less than X₁ RB(s) are allocated) on the first set of RBs, may be cancelled/skipped on the symbol (e.g., and other associated symbol(s) for the UL resource). Reception (e.g., any reception) of a DL resource (e.g., scheduled, configured, or indicated to measure/monitor such as PDCCH, PDSCH, SPS-PDSCH, DL-RS, etc.) may be cancelled/skipped on the symbol (e.g., and other associated symbol(s) for the DL resource due to of HD-WTRU operations). The cancelling/skipping may mean that, in other reception occasion(s) of the DL resource, reception of the DL resource may be performed by the WTRU (e.g., depending on a condition for each reception occasion and/or if the DL resource is periodic or semi-persistent). X₁, R_{UL}, and/or D₁ may be configured, pre-defined, or indicated.

The WTRU may identify/determine that the symbol (e.g., slot) is used for ‘UL’ based on an implicit determination and/or an explicit indication. In examples, by implicit determination, the WTRU may identify/determine that the symbol (e.g., slot) is used for ‘UL’ if there exists at least one UL Tx (e.g., scheduled/configured/indicated) over at least U1 RB(s) among the first set of RBs (e.g., and/or, if there exists no DL Rx scheduled/configured/indicated over at least U2 RB(s) among the first set of RBs). U1 and/or U2 may be configured, pre-defined, or indicated (e.g., they may be identical). In examples, the WTRU may identify/determine that the symbol (e.g., slot) is used for ‘UL’ based on a legacy configuration (e.g., tdd-UL-DL-config-common/dedicated), e.g., according to the indicated symbol(s)/slot(s) marked with ‘U’ (e.g., and/or ‘F’). This may mean the UL symbol(s)/slot(s) (e.g., as being indicated to be an actual communication direction as UL on the UL symbol(s)/slot(s)) are to be indicated by the legacy configuration(s), e.g., legacy DCI format 2_0, (e.g., for supporting HD-WTRU) and a new tdd-UL-DL-config (e.g., for XDD) comprising one or more ‘Mₙ’ type(s) may be separately/independently informed to the WTRU, where the new tdd-UL-DL-config may have overlapped indications of a selective ‘Mₙ’ type on a same symbol as being marked with ‘D’ or ‘U’ in the legacy configuration. Allowing this overlap may result in that the new tdd-UL-DL-config (e.g., for XDD) has a purpose of checking resource validity with the at least one cancelling/skipping condition(s) (e.g., in terms of XDD operations such as for HD-WTRUs) in RB(s) level, although the actual communication direction/link for either UL or DL may be indicated by the legacy configuration(s), e.g., via DCI format 2_0.

In the case where transmission (e.g., any transmission) of a UL resource (e.g., scheduled, configured, or indicated to transmit such as PUCCH, PUSCH, CG-PUSCH, UL-RS, etc.), if not fully allocated (e.g., if less that X₁ RB(s) are allocated) on the first set of RBs, may be cancelled/skipped on the symbol (e.g., and other associated symbol(s) for the UL resource), one or more of the following may apply. The cancelling/skipping condition may be pre-defined/pre-configured/indicated. The cancelling/skipping condition may be pre-defined/pre-configured/indicated per particular channel(s)/signal(s), (e.g., per at least one among PUCCH, PUSCH, SRS, PRACH, etc.). In examples, the cancelling/skipping condition may be based on determining a ratio R₁ of a first number of RB(s) for the UL resource being fully overlapped with the first set of RBs to a second number of RB(s) for the UL resource being not overlapped with the first set of RBs. If the ratio R₁ is less than a threshold R_{UL}, transmission of the UL resource may be cancelled/skipped on the symbol (e.g., and other associated symbol(s) for the UL resource). In examples, the cancelling/skipping condition may be based on checking whether all symbols (e.g., or D₁ symbols) for transmission of the UL resource (e.g., for slot(s) are satisfied with at least one condition(s) described herein. If satisfied, the UL resource may be transmitted. If not all symbols (e.g., or D₁ symbols) are satisfied, transmission of the UL may be cancelled/skipped for a corresponding transmit occasion (e.g., for slot(s)). In examples, the cancelling/skipping condition may be determined/defined/configured (e.g., independently determined/defined/configured) based on whether the UL resource is scheduled by a DCI (e.g., a dynamic scheduling/grant case) or by a higher-layer signaling (e.g., a semi-static scheduling case, configured-grant case, etc.). The cancelling/skipping may mean that, in other transmission occasion(s) of the UL resource, transmission of the UL resource may be performed by the WTRU (e.g., depending on a condition for each transmission occasion, and/or if the UL resource is periodic or semi-persistent).

In the case where the WTRU may determine that the second set of RBs are valid as DL for scheduled/configured DL receptions (e.g., PDCCH, PDSCH, SPS-PDSCH, and/or RS measurements), and the WTRU may perform the DL Rx on the second set of RBs, for example, if the WTRU identifies/determines that the symbol (e.g., slot) is used for ‘DL’ (e.g., and not for ‘UL’, without mixing UL and DL in the same symbol/slot) and otherwise, (e.g., if the WTRU identifies/determines that the symbol/slot is used for ‘UL’), the DL reception(s) (e.g., reception of a DL resource) may be cancelled/skipped on the symbol (/slot), one or more of the following may apply. The cancelling/skipping may mean that, in other reception occasion(s) of the DL resource, reception of the DL resource may be performed by the WTRU (e.g., depending on a condition for each reception occasion and/or if the DL resource is periodic or semi-persistent).

In the case where the WTRU determines that the second set of RBs are valid as DL for scheduled/configured DL receptions (e.g., PDCCH, PDSCH, SPS-PDSCH, and/or RS measurements), and the WTRU may perform the DL Rx on the first set of RBs, for example, if the WTRU identifies/determines that the symbol (e.g., slot) is used for ‘DL’ (e.g., and not for ‘UL’, without mixing UL and DL in the same symbol (/slot)) and otherwise, (e.g., if the WTRU identifies/determines that the symbol/slot is used for ‘UL’), the DL reception(s) (e.g., reception of a DL resource) may be cancelled/skipped on the symbol (e.g., slot), one or more of the following may apply. The WTRU may identify/determine that the symbol (e.g., slot) is used for ‘DL’. Reception (e.g., any reception) of a DL resource (e.g., scheduled, configured, or indicated to measure/monitor such as PDCCH, PDSCH, SPS-PDSCH, DL-RS, etc.), if not fully allocated (e.g., if less than Y₁ RB(s) are allocated) on the second set of RBs, may be cancelled/skipped on the symbol (e.g., and other associated symbol(s) for the DL resource). Transmission (e.g., any transmission) of a UL resource (e.g., scheduled, configured, or indicated to transmit such as PUCCH, PUSCH, CG-PUSCH, UL-RS, etc.) may be cancelled on the symbol (e.g., and other associated symbol(s) for the UL resource due to of HD-WTRU operations). The cancelling/skipping may mean that, in other reception occasion(s) of the UL resource, transmission of the UL resource may be performed by the WTRU (e.g., depending on a condition for each transmission occasion and/or if the UL resource is periodic or semi-persistent). Y₁, R_{DL}, and/or D₂ may be configured, pre-defined, or indicated.

The WTRU may identify/determine that the symbol (e.g., slot) is used for ‘DL’ based on an implicit determination and/or an explicit indication. In examples, by implicit determination, the WTRU may identify/determine that the symbol (e.g., slot) is used for ‘DL’ if there exists at least one DL Rx (e.g., scheduled/configured/indicated) over at least D1 RB(s) among the second set of RBs (e.g., and/or, if there exists no UL Tx scheduled/configured/indicated over at least D2 RB(s) among the second set of RBs). D1 and/or D2 may be configured, pre-defined, or indicated (e.g., they may be identical). In examples, the WTRU may identify/determine that the symbol (e.g., slot) is used for ‘DL’ based on a legacy configuration (e.g., tdd-UL-DL-config-common/dedicated), e.g., according to the indicated symbol(s)/slot(s) marked with ‘D’ (e.g., and/or ‘F’). This may mean the DL symbol(s)/slot(s) (e.g., as being indicated to be an actual communication direction as DL on the DL symbol(s)/slot(s) are to be indicated by the legacy configuration(s), e.g., legacy DCI format 2_0, (e.g., for supporting HD-WTRU) and a new tdd-UL-DL-config (e.g., for XDD) comprising one or more ‘Mₙ’ type(s) may be separately/independently informed to the WTRU, where the new tdd-UL-DL-config may have overlapped indications of a selective ‘Mₙ’ type on a same symbol as being marked with ‘D’ or ‘U’ in the legacy configuration. Allowing the overlap may result in the new tdd-UL-DL-config (e.g., for XDD) having a purpose of checking resource validity with the at least one cancelling/skipping condition(s) (e.g., in terms of XDD operations such as for HD-WTRUs) in RB(s) level, although the actual communication direction/link for either UL or DL may be indicated by the legacy configuration(s), e.g., via DCI format 2_0.

In the case where reception (e.g., any reception) of a DL resource (e.g., scheduled, configured, or indicated to measure/monitor such as PDCCH, PDSCH, SPS-PDSCH, DL-RS, etc.), if not fully allocated (e.g., if less than Y₁ RB(s) are allocated) on the second set of RBs, is cancelled/skipped on the symbol (e.g., and other associated symbol(s) for the DL resource), one or more of the following may apply. The cancelling/skipping condition may be pre-defined/pre-configured/indicated. The cancelling/skipping condition may be pre-defined/pre-configured/indicated per particular channel(s)/signal(s) (e.g., per at least one among PDCCH such as CORESET and/or search space, PDSCH, CSI-RS, etc.). In examples, the cancelling/skipping condition may be based on determining a ratio R₂ of a first number of RB(s) for the DL resource being fully overlapped with the second set of RBs to a second number of RB(s) for the DL resource being not overlapped with the second set of RBs. If the ratio R₂ is less than a threshold R_{DL}, reception of the DL resource may be cancelled/skipped on the symbol (e.g., and other associated symbol(s) for the DL resource). In examples, the cancelling/skipping condition may be based on checking whether all symbols (e.g., or D₂ symbols) for reception of the DL resource (e.g., for slot(s) are satisfied with at least one condition(s) described herein. If satisfied, the DL resource may be received. If not all symbols (e.g., or D₂ symbols) are satisfied, reception of the DL may be cancelled/skipped for a corresponding reception occasion (e.g., for slot(s)). In examples, the cancelling/skipping condition may be determined/defined/configured (e.g., independently determined/defined/configured) based on whether the DL resource is scheduled by a DCI (e.g., a dynamic scheduling/grant case) or by a higher-layer signaling (e.g., a semi-static scheduling case, configured-grant case, etc.). The cancelling/skipping may mean that, in other reception occasion(s) of the DL resource, reception of the DL resource may be performed by the WTRU (e.g., depending on a condition for each reception occasion and/or if the DL resource is periodic or semi-persistent).

Priority rule(s) for a resource validity check based on ‘Mₙ’ type(s) may be provided. For at least one condition regarding how the WTRU identifies/determines that the symbol is used for ‘UL’ (e.g., or ‘DL’) as described herein for checking resource validity (e.g., in terms of XDD operations such as for HD-WTRU(s) in RB(s) level, if both ‘DL’ and ‘UL’ are identified/determined as valid on a symbol(s)/slot(s)) (e.g., if a legacy signaling of tdd-UL-DL-config-common/dedicated and/or DCI-based SFI signaling via DCI format 2_0 indicates an ‘F’ on the symbol(s)/slot(s)), one or more of the following may apply. A priority rule may apply according to at least one priority rule among multiple priority rules which are described as follows. The priority may be set differently per different DL/UL channel(s)/signal(s).

In the case where a priority rule applies according to at least one priority rule among multiple priority rules, one or more of the following may apply. ‘DL’ may have higher-priority than ‘UL’. For example, if the priority is set to ‘DL’, the WTRU may identify/determine the symbol(s)/slot(s) is/are used for ‘DL’, and may apply at least one behavior described herein corresponding to DL. Alternatively, ‘UL’ may have higher-priority than ‘DL.’ For example, if the priority is set to ‘UL’, the WTRU may identify/determine the symbol(s)/slot(s) is/are used for ‘UL’, and may apply at least one behavior described herein corresponding to UL.

In the case where the priority is set differently per different DL/UL channel(s)/signal(s), one or more of the following may apply. For example, DL/UL control channel(s) (e.g., PDCCH/PUCCH) may have higher priority than DL/UL data channel(s) (e.g., PDSCH/PUSCH). For example, if the WTRU identifies/determines both a PDCCH (e.g., as a DL control channel) and PUSCH (e.g., as a UL data/shared channel) are valid on a symbol(s)/slot(s), then, based on the priority, the WTRU may identify/determine the symbol(s)/slot(s) is/are used for ‘DL’, and may apply at least one behavior described herein corresponding to DL. For example, if the WTRU identifies/determines both a PUCCH (e.g., as a UL control channel) and PDSCH (e.g., as a DL data/shared channel) are valid on a symbol(s)/slot(s), then based on the priority, the WTRU may identify/determine the symbol(s)/slot(s) is/are used for ‘UL’, and may apply at least one behavior described herein corresponding to UL. Control/data channel(s) (e.g., at least one among PDCCH/PUCCH/PDSCH/PUSCH) may have higher priority than RS(s) (e.g., at least one among CSI-RS, and/or SRS). For example, if the WTRU identifies/determines both a PDSCH (e.g., as a DL data/shared channel) and SRS (e.g., as a UL RS) are valid on a symbol(s)/slot(s), then based on the priority, the WTRU may identify/determine the symbol(s)/slot(s) is/are used for ‘DL’, and may apply at least one behavior described herein corresponding to DL. For example, if the WTRU identifies/determines both a PUSCH (e.g., as a UL data/shared channel) and CSI-RS (e.g., as a DL RS) are valid on a symbol(s)/slot(s), then based on the priority, the WTRU may identify/determine the symbol(s)/slot(s) is/are used for ‘UL’, and may apply at least one behavior described herein corresponding to UL. Among control channel(s), first control channel(s) being associated with at least one common search space may have higher priority than second control channel(s) being associated with no common search space (e.g., being associated only with WTRU-specific search space(s).

Behaviors based on indicated muted RBs (e.g., and/or ‘Mₙ’ type(s) may be provided. In examples, based on at least one condition described herein being met (e.g., for a symbol/slot, if the symbol/slot corresponds to, belongs to, is associated with, and/or is configured/indicated by an ‘Mₙ’ type) and/or if at least one indication(s) described herein on muted RB(s) is given to a WTRU, one or more of the following (e.g., WTRU behaviors based on ‘Mₙ’ type(s) such as for FD-WTRU and/or HD-WTRU) may apply. For an active DL BWP (e.g., for receiving a DL on a slot/symbol), if the WTRU receives a muting command on DL RB(s) according to at least one example described herein, on corresponding symbol(s) where the muted DL RB(s) are applied, one or more of the following may apply. For an active UL BWP (e.g., for transmitting a UL on a slot/symbol), if the WTRU receives a muting command on UL RB(s) according to at least one example described herein, on corresponding symbol(s) where the muted UL RB(s) are applied, one or more of the following may apply.

In the case where the WTRU receives a muting command on DL RB(s) according to at least one example described herein, on corresponding symbol(s) where the muted DL RB(s) are applied, one or more of the following may apply. Reception (e.g., any reception) of a DL resource (e.g., scheduled, configured, or indicated to measure/monitor such as PDCCH, PDSCH, SPS-PDSCH, CSI-RS, etc.), if not fully (or not more than X RBs) overlapped with the muted DL RB(s) and/or if the resource validity check for DL based on ‘Mₙ’ type(s) is successful/satisfied (e.g., being determined as at least valid for DL, etc.), may be performed by the WTRU on the symbol(s) (e.g., and other associated symbol(s) for the DL resource). The performing of the reception of the DL resource may be applicable (e.g., be configured to do so) by applying the muting (e.g., or rate matching or RB(s)-level frequency resource skipping, or RB(s)-level puncturing, etc.) on the DL RB(s) corresponding to the muting command within second DL RB(s) (e.g., scheduled, configured, or indicated to measure/monitor) allocated for the DL resource. The receiving RB(s) for the DL resource may be third RB(s) as a part of the second RB(s), where the third RB(s) may have (e.g., result in) discontinuous RB allocation due to the muting command on the DL RB(s). Reception (e.g., any reception) of a DL resource (e.g., scheduled, configured, or indicated to measure/monitor such as PDCCH, PDSCH, SPS-PDSCH, CSI-RS, etc.), if (e.g., fully, partially, or more than X RBs) overlapped with the muted DL RB(s) and/or if the resource validity check for DL based on ‘Mₙ’ type(s) is failed (e.g., being determined as not valid for DL, etc.), may be cancelled/skipped on the symbol(s) (e.g., and other associated symbol(s) for the DL resource). The cancelling/skipping may mean that, in other reception occasion(s) of the DL resource, reception of the DL resource may be performed by the WTRU (e.g., depending on a condition for each reception occasion, and/or if the DL resource is periodic or semi-persistent). X may be pre-defined, pre-configured, or indicated (e.g., separately indicated). A CSI (e.g., an associated CSI or BM) reporting as UL Tx based on measuring the DL resource (e.g., CSI-RS resource(s) and/or SSB index(es)), if the DL resource is (e.g., fully, partially, or more than X RBs) overlapped with the muted DL RB(s) and/or if the resource validity check for DL based on ‘Mₙ’ type(s) is failed (e.g., being determined as not valid for DL, etc.), may be cancelled/skipped on second symbol(s)/slot(s) on which the CSI (e.g., associated CSI or BM) reporting is scheduled/configured/indicated. This may be applicable at least for wideband reporting for the CSI (e.g., or BM) reporting. If the WTRU is configured/indicated to perform a subband reporting as UL Tx (e.g., in addition to a wideband reporting) based on measuring the DL resource (e.g., CSI-RS resource(s) and/or SSB index(es)), the WTRU may skip reporting for subband(s) (e.g., only the subbands) which are (e.g., fully, partially, or more than Z RBs) overlapped with the muted DL RB(s) (e.g., and/or overlapped with the RB(s) portion being not indicated as ‘DL’ according to a selective ‘Mₙ’ type indicated on the symbol(s). Z may be pre-defined, pre-configured, or indicated (e.g., separately indicated). For example, if the WTRU is configured/indicated to report the subband reporting on 4 subbands (e.g., comprising a first subband, a second subband, a third subband, and a fourth subband), and the first subband and the third subband are overlapped with more than Z RBs within the muted DL RB(s) (e.g., and/or within the RB(s) portion being not indicated as ‘DL’ according to a selective ‘Mₙ’ type indicated on the symbol(s)), the WTRU may report the subband reporting being comprised with a second subband-CSI (e.g., derived on the second subband) and a fourth subband-CSI (e.g., derived on the fourth subband), and a first subband-CSI (e.g., corresponding to the first subband), and a first subband-CSI (e.g., corresponding to the first subband) and a third subband-CSI (e.g., corresponding to the third subband) may be skipped (e.g., not reported as a part of the subband reporting). The parameter Z may be given independently/separately per subband. For example, Z₁, Z₂, etc. may be pre-configured or indicated (e.g., separately indicated), where Z₁ is used as the above Z for the first subband, Z₂ is used as the above Z for the second subband, and so on, depending on configuration(s)/indications(s) from the gNB (e.g., Zₖ parameter for every subband, for a group of subband, or for a group of RB(s), etc.).

In the case where the WTRU receives a muting command on UL RB(s) according to at least one example described herein, on corresponding symbol(s) where the muted UL RB(s) are applied, one or more of the following may apply. Transmission (e.g., any transmission) of a UL resource (e.g., scheduled, configured, or indicated to transmit such as PUCCH, PUSCH, CG-PUSCH, SRS, etc.), if not fully (e.g., or not more than Y RBs) overlapped with the muted UL RB(s) and/or if the resource validity check for UL based on ‘Mₙ’ type(s) is successful/satisfied (e.g., being determined as at least valid for UL, etc.), may be performed by the WTRU on the symbol(s) (e.g., and other associated symbol(s) for the UL resource). The performing of the transmission of the UL resource may be applicable (e.g., be configured to do so) by applying the muting (e.g., or rate matching or RB(s)-level frequency resource skipping, etc.) on the UL RB(s) corresponding to the muting command within second UL RB(s) (e.g., scheduled, configured, or indicated to transmit) allocated for the UL resource. This may mean the transmitting RB(s) for the UL resource may be third RB(s) as a part of the second RB(s), where the third RB(s) may have (e.g., result in) discontinuous RB allocation due to the muting command on the UL RB(s). Transmission (e.g., any transmission) of a UL resource (e.g., scheduled, configured, or indicated to transmit such as PUCCH, PUSCH, CG-PUSCH, SRS, etc.), if (e.g., fully, partially, or more than Y RBs) overlapped with the muted UL RB(s) and/or if the resource validity check for UL based on ‘Mₙ’ type(s) is failed (e.g., being determined as not valid for UL, etc.), may be cancelled/skipped on the symbol(s) (e.g., and other associated symbol(s) for the UL resource). The cancelling/skipping may mean that, in other transmission occasion(s) of the UL resource, transmission of the UL resource may be performed by the WTRU (e.g., depending on a condition for each transmission occasion and/or if the UL resource is periodic or semi-persistent). Y may be pre-defined, pre-configured, or indicated (e.g., separately indicated).

PDCCH monitoring behaviors based on the ‘Mₙ’ type(s) and/or muted RB(s) may be provided. XDD mode may refer to one or more of following: a mode of operation in which a new type of slot format indicator (e.g., XDD slot format indicator) may be used, where the new type of slot format indicator may indicate a first portion of resources which may be associated with a first direction (e.g., downlink), a second portion of resources which may be associated with a second direction (e.g., uplink), and a third portion of resources which may be associated with a third direction (e.g., sidelink); a mode of operation in which a gNB may indicate transmission direction (e.g., uplink or downlink) for a portion of the resources (e.g., time/frequency resource), where the transmission direction indication may be based on semi-static signaling (e.g., RRC or MAC-CE) or dynamic signaling (L1 signaling, DCI, SCI, etc.); a mode of operation in which a first portion of resources and a second portion of resources within a slot (e.g., or symbol) may be associated with a different transmission direction (e.g., the first portion of resources in a slot may be associated with downlink and the second portion of resources in the slot may be associated with uplink); and/or a mode of operation in which a first portion of resources may be used for a transmission direction at a time and a second portion of resources may be used for multiple transmission directions (e.g., downlink and uplink) at the same time.

The term “XDD” may be interchangeably used with Subband Full Duplex (SFD), Full duplex (FD), and/or Cross Division Duplex (CDD). Non-XDD mode may be referred to as one or more of the following: a mode of operation in which one or more slot format indicator may be used and the one or more slot format indicator may determine a transmission direction of slot or symbol (e.g., downlink, uplink, or sidelink); and/or a mode of operation in which a single transmission direction is used for a slot or symbol.

XDD slot may refer to one or more of the following: a slot that may include a first portion of resources which may be associated with a first transmission direction (e.g., downlink) and a second portion of resources which may be associated with a second transmission direction (e.g., uplink); a slot that may include a set of resources of which the transmission direction may include multiple transmission directions (e.g., downlink and uplink); and/or a slot may be associated with a new slot format indicator (e.g., Mₙ). For example, XDD slot format may be indicated with a new slot format indicator. XDD slot format indicator may be referred to as a slot format indicator which may indicate one of the XDD slot formats. An XDD slot format may include at least one of DL resource, UL resource, or flexible resource.

The term “XDD slot” may be interchangeably used with XDD symbol, XDD bandwidth part, XDD time/frequency resource, XDD time window, and/or XDD time resource. The term “Non-XDD slot/symbol” may refer to a slot/symbol which includes time/frequency resources used for a single transmission direction (e.g., downlink, uplink, or sidelink).

Association between XDD mode/slot and search space/CORESET may be provided. In examples, a WTRU may be configured with one or more CORESETs and/or one or more search spaces, where a CORESET and/or a search space may be associated with a mode of operation (e.g., XDD mode/slot or non-XDD mode/slot). A WTRU may receive configuration information for a CORESET and/or a search space, where the configuration (e.g., configuration information) may include its associated mode of operation (e.g., XDD mode or non-XDD mode). A CORESET associated with a first mode of operation (e.g., XDD mode) may be provided. A search space associated with a first mode of operation (e.g., XDD mode) may be provided.

In the case where a WTRU receives configuration information for a CORESET and/or a search space, where the configuration information may include its associated mode of operation (e.g., XDD mode or non-XDD mode), one or more of the following may apply. A WTRU may determine a monitoring set of control information (e.g., DCI format, SFI type, and/or a bit field interpretation) in a search space based on its associated mode of operation. For example, a WTRU may monitor an indication of a new SFI type (e.g., XDD slot format indication) in a search space configured with a first mode of operation (e.g., XDD mode). The WTRU may monitor for an indication of existing SFI types (e.g., non-XDD slot format indication) in a search space configured with a second mode of operation (e.g., non-XDD mode). A WTRU may determine a slot type for a slot comprising a search space based on the mode of operation associated with the search space. For example, a WTRU may determine a slot as a first slot type (e.g., XDD slot) if the search space monitored in the slot is associated with a first mode of operation (e.g., XDD mode). A WTRU may determine a slot as a second slot type (e.g., non-XDD slot) if the search space monitored in the slot is associated with a second mode of operation (e.g., non-XDD mode). If a search space is associated with a single CORESET, the mode of operation associated with the search space may be determined based on the mode of operation configured for the CORESET associated with the search space.

A CORESET associated with a first mode of operation (e.g., XDD mode) may be provided. A subset of RBs within a BWP may not be used for the CORESET configuration. For example, a set of RBs in the middle of BWP may be considered as not available resources for CORESET and a WTRU may expect that the set of RBs configured for the CORESET associated with the first mode of operation does not include the set of RBs. A subset of resources configured for the CORESET may be indicated as a disabled state, where the disabled state may be interchangeably used with unusable, dropped, flipped to an uplink resource, muted, or punctured state. If a subset of resources for a CORESET is disabled, one or more of following may apply. A WTRU may skip monitoring one or more PDCCH candidates associated with the CORESET. A WTRU may monitor a subset of PDCCH candidates which has no disabled resources (e.g., CCE, REG, and/or REG bundles) within the PDCCH candidate resource. A WTRU may determine monitoring of a PDCCH candidate based on whether one or more resources for the PDCCH candidate is disabled or not.

A search space associated with a first mode of operation (e.g., XDD mode) may be provided. A set of time resources configured for the search space may be allowed and/or configured for the first mode of operation (e.g., XDD mode), where one or more of the following time resources may be not allowed or used for the first mode of operation: a time resource (e.g., slot or symbol) which includes a synchronization signal (e.g., SS/PBCH block); a time resource which may be used for measurement (e.g., RRM measurement, neighboring cell measurement, positioning measurement, etc.); a time resource which may be configured for a purpose (e.g., URLLC, mMTC, sidelink operation, and/or NTN); and/or a time resource which may be configured to indicate mode of operation. For example, a set of time resources (e.g., slots) may be configured for a WTRU to monitor an indication (e.g., SFI, XDD slot configuration) and the set of time resources may be used as non-XDD mode. A WTRU may monitor the search space associated with the first mode of operation (e.g., XDD mode), for example, if the WTRU is indicated to operate the first mode of operation. Otherwise, the WTRU may skip monitoring the search space associated with the first mode of operation.

The term “Search space” may be interchangeably used with PDCCH search space, monitoring search space, control channel search space, and PSCCH search space.

Search space configurations for XDD and non-XDD modes may be provided. In examples, a WTRU may be configured with one or more sets of search spaces, where a first set of search spaces may be associated with a first mode of operation (e.g., XDD mode) and a second set of search spaces may be associated with a second mode operation (e.g., non-XDD mode). The time resources for the first set of search spaces may be non-overlapped with that for the second set of search spaces. An XDD slot format indicator may be used for the slots associated with the first set of search spaces. There may be an overlap (e.g., or conflict) between time resources configured for the first set of search spaces and the second set of search spaces. Contents of a DCI format may be different based on the monitoring search space set.

In the case where an XDD slot format indicator is used for the slots associated with the first set of search spaces, one or more of the following may apply. For example, a WTRU may determine an XDD slot format for the slots associated with the first set of search spaces, where the XDD slot format may be indicated via a higher layer signaling (e.g., RRC or MAC-CE), and/or L1 signaling (e.g., DCI). The WTRU may determine a non-XDD slot format (e.g., indicated or configured) for the slots associated with the second set of search spaces.

In the case where there is an overlap (e.g., or conflict) between time resources configured for the first set of search spaces and the second set of search spaces, one or more of the following may apply. A WTRU may determine the time resource is used for the first set of search space (e.g., or the second set of search space). A WTRU may skip monitoring the time resource. A WTRU may monitor both first set of search spaces and the second set of search spaces, for example, if the frequency resources are not overlapped (e.g., and the frequency resources for the second set of search spaces are still indicated as downlink resource in XDD slot format indicator).

In the case where contents of a DCI format are different based on the monitoring search space set, one or more of the following may apply. In examples, a WTRU may determine a first set of DCI contents for a DCI format when the WTRU monitors the DCI format in a first set of search spaces and the WTRU may determine a second set of DCI contents for the DCI format when the WTRU monitors the DCI format in a second set of search spaces. A first DCI content (e.g., XDD slot format indicator) may be included in a first set of DCI contents and not included in a second set of DCI contents. A second DCI content (e.g., frequency resource allocation field) may have a first size in a first set of DCI contents and a second size in a second set of DCI contents. For example, the first size may be greater than the second size based on the assumption that a non-XDD slot may have a larger number of resources for downlink or uplink than an XDD slot.

In examples, a first search space type (e.g., a common search space) may be associated with a first mode of operation (e.g., non-XDD mode) and a second search space type (e.g., a WTRU-specific search space) may be associated with one of the modes of operations (e.g., XDD mode or non-XDD mode). A WTRU may determine a slot which includes a search space with a first search space type (e.g., common search space) as a non-XDD slot. A WTRU may determine a set of resources (e.g., RBs) configured for a search space with a first search space type (e.g., common search space) as downlink resource. A WTRU may assume that XDD slot format indicator is not applied or used for the slot comprising a search space with a first search space type (e.g., common search space). The first search space type may be a search space associated with a default CORESET (e.g., CORESET #0).

In examples, a WTRU may determine to monitor a search space in a slot based on the number of resources for the search space which is re-allocated for uplink. In examples, in XDD slot, if at least one of resources for the search space is re-allocated for uplink, the WTRU may skip monitoring the search space. In examples, if the number of resources for the search space re-allocated for uplink is larger than a threshold, the WTRU may skip monitoring the search space, where the threshold may be pre-determined, configured, or indicated by gNB.

The resource for a CORESET may be a time/frequency resource determined based on the CORESET configuration information and its associated search space configuration information. For example, CORESET configuration information may determine frequency resource and number of symbols within a slot and search space configuration information may determine time resource (e.g., slot and starting symbol within the slot).

Resources for search space may be interchangeably used with resources for CORESET.

A WTRU may monitor a search space associated with multiple CORESETs. In examples, a search space may be associated with one or more CORESETs (e.g., CORESET identities and/or CORESET-id) and a WTRU may determine which CORESET (e.g., CORESET-id) to use for monitoring the search space based on slot type determined for the slot in which the WTRU monitors the search space. In examples, a WTRU may be configured with a search space which may be associated with a first CORESET (e.g., CORESET-id=1) and a second CORESET (e.g., CORESET-id=2). The WTRU may monitor the search space with the first CORESET in a slot which may be determined as XDD slot. The WTRU may monitor the search space with the second CORESET in a slot which is determined as non-XDD slot, where the first CORESET and the second CORESET may have a different set of RBs within a BWP. A WTRU may determine a CORESET (e.g., a CORESET within the CORESETs associated with the search space) for monitoring the search space If more than one CORESET is associated with a search space, a first CORESET associated with the search space may be referred to as a default CORESET and a second CORESET associated with the search space may be referred to as a secondary CORESET.

In the case where a WTRU determines a CORESET (e.g., a CORESET within the CORESETs associated with the search space) for monitoring the search space, one or more of the following may apply. The WTRU may determine the CORESET (e.g., within the CORESETs associated with the search space) based on a mode of operation (e.g., being indicated). For example, the WTRU may be indicated the mode of operation (e.g., XDD mode or non-XDD mode) via higher layer signaling or L1 (e.g., Layer-1 and/or physical-layer) signaling. The WTRU may determine the CORESET (e.g., within the CORESETs associated with the search space) based on a slot format indicator (SFI) value (e.g., being indicated/provided). For example, the WTRU may determine to use a first CORESET if a first SFI value is indicated for the slot where the WTRU monitors the search space. The WTRU may determine to use a second CORESET, for example, if a second SFI value is indicated for the slot where the WTRU monitors the search space. The WTRU may determine the CORESET (e.g., within the CORESETs associated with the search space) based on one or more system parameters including slot index, subcarrier spacing, bandwidth, and/or frequency band (e.g., being provided/indicated).

In the case where more than one CORESET is associated with a search space, a first CORESET associated with the search space may be referred to as a default CORESET and a second CORESET associated with the search space may be referred to as a secondary CORESET, one or more of the following may apply. A WTRU may determine to use the default CORESET for monitoring the associated search space irrespective of the slot type, for example, if the configured resource for the default CORESET remains the downlink resource, e.g., based on an indicated ‘Mₙ’ type. A WTRU may determine to use a secondary CORESET for monitoring the associated search space, for example, if one or more resources for the default CORESET are indicated to use for another transmission direction (e.g., uplink). The resources for a CORESET which is indicated to use for another transmission direction may be referred to as flipped resources, interrupted resources, dropped resources, muted resources, re-allocated resources (e.g., for uplink), and/or switched resources. The secondary CORESET may be used if the number of flipped resources is larger than a threshold. If more than one secondary CORESET is configured, a secondary CORESET which satisfies one or more following condition(s) may be used: a CORESET with the number of flipped resources less than the threshold in the slot, a CORESET with no flipped resource in the slot, a CORESET configured with a first mode of operation (e.g., XDD mode), and/or a CORESET with a lowest CORESET-id within the secondary CORESETs configured. A WTRU may determine to use a default CORESET for monitoring the associated search space in a slot determined as non-XDD slot; otherwise, the WTRU may determine to use a secondary CORESET for monitoring the associated search space. A WTRU may be indicated which CORESET to use for monitoring the associated search space via a higher layer signaling (e.g., RRC and/or MAC-CE) or L1 signaling (e.g., DCI). A WTRU may be indicated which CORESET to use (e.g., CORESET-id) for slot #n at slot #n-K, wherein K may be a positive integer.

In examples, a WTRU may be configured with a search space with one or more associated CORESETs, and the WTRU may monitor the search space with one or more (e.g., all) associated CORESETs. A WTRU may skip monitoring a PDCCH candidate if there is any flipped resource for the PDCCH candidate. If the total number of PDCCH candidates is larger than a threshold, a WTRU may skip monitoring one or more PDCCH candidates based on priority. A WTRU may monitor the search space with all associated CORESETs in a first slot type (e.g., non-XDD slot) and the WTRU may monitor the search space with a subset of associated CORESETs in a second slot type (e.g., XDD slot).

In the case where the total number of PDCCH candidates is larger than a threshold, a WTRU may skip monitoring one or more PDCCH candidates based on priority, where the priority may be determined based on one or more of the following. The priority may be determined based on CORESET-id. For example, a PDCCH candidate associated with lower CORESET-id may be considered as a higher priority (e.g., or lower priority). The priority may be determined based on CCE aggregation level. For example, a PDCCH candidate with lower aggregation level may be considered as a higher priority (e.g., or lower priority). The priority may be determined based on REG bundle size. For example, a PDCCH candidate with a larger REG bundle size may be considered as a higher priority (e.g., or lower priority).

In the case where a WTRU monitors the search space with one or more (e.g., all) associated CORESETs in a first slot type (e.g., non-XDD slot) and the WTRU monitors the search space with a subset of associated CORESETs in second slot type (e.g., XDD slot), the subset of CORESETs may be determined based on at least one of whether there is any flipped resource for the CORESET and/or whether the CORESET is configured for a mode of operation (e.g., XDD mode).

BWP configuration information may be provided. A WTRU may be configured with one or more BWPs, where a first BWP (e.g., default BWP or BWP #0) may be associated with a first mode of operation (e.g., non-XDD mode) and a second BWP may be associated with a second mode of operation (e.g., XDD mode). The BWP configuration information may include a mode of operation (e.g., XDD mode or non-XDD mode). The first BWP (e.g., default BWP or BWP #0) may be identical to (e.g., shared with) a third BWP (e.g., ‘default’ BWP), e.g., which may be activated based on the expiration of the BWP inactivity timer. The first BWP (e.g., default BWP or BWP #0) may be identical to (e.g., shared with) a fourth BWP (e.g., ‘initial’ BWP), e.g., which may be used for initial access (e.g., until the WTRU receives dedicated configuration parameters such as RRC connection).

In the case where a BWP configuration information includes a mode of operation (e.g., XDD mode or non-XDD mode), one or more of the following may apply. If a WTRU is configured with a BWP and a first mode of operation (e.g., XDD mode), the WTRU may expect to monitor a DCI which may include XDD slot format indicator. A WTRU may not expect to receive XDD slot format indicator in a BWP which is configured for non-XDD mode.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1-15. (canceled)

16. A method implemented in a wireless transmit/receive unit (WTRU), the method comprising:
receiving an indication that each of one or more symbols include both a first subset of resource blocks associated with downlink (DL) reception and a second subset of resource blocks associated with uplink (UL) transmission;
receiving a DL transmission associated with one or more periodic DL resources in the one or more symbols on a condition that the one or more periodic DL resources are comprised in the first subset of resource blocks associated with DL reception for the one or more symbols; and
transmitting a first UL transmission associated with one or more periodic UL resources in the one or more symbols on a condition that the one or more periodic UL resources are comprised in the second subset of resource blocks associated with UL transmission for the one or more symbols.

17. The method of claim 16, further comprising receiving configuration information, the configuration information indicating a plurality of UL/DL resource block patterns for the one or more symbols.

18. The method of claim 17, wherein the plurality of UL/DL resource block patterns are indicated in the RRC message using a bitmap.

19. The method of claim 17, wherein the indication is received via downlink control information (DCI) or a medium access control (MAC) control element (CE), and the indication indicates which of the plurality of UL/DL resource block patterns indicated in the configuration information is to be applied for the one or more symbols.

20. The method of claim 19, wherein the indication indicates a first UL/DL resource block pattern of the plurality of UL/DL resource block patterns is to be applied for a first symbol of the one or more symbols, and the indication indicates a second UL/DL resource block pattern of the plurality of UL/DL resource block patterns is to be applied for a second symbol of the one or more symbols.

21. The method of claim 17, wherein an RRC message comprises the configuration information.

22. The method of claim 16, further comprising:
receiving an uplink grant for one or more second periodic UL resources in the one or more symbols;
determining that a second UL transmission associated with the one or more second periodic UL resources is to be transmitted in one or more of the first subset of resource blocks associated with DL reception;
determining that the one or more of the first subset of resource blocks associated with DL reception are not available for UL transmissions based on the indication; and
dropping the second UL transmission based on the determination that the second UL transmission associated with the one or more second periodic UL resources is to be transmitted in the one or more of the first subset of resource blocks associated with DL reception and the determination that the one or more of the first subset of resource blocks associated with DL reception are not available for UL transmissions.

23. The method of claim 16, wherein the periodic UL resources are for one or more of a physical uplink control channel (PUCCH) or a configured grant-physical uplink shared channel (CG-PUSCH).

24. The method of claim 16, further comprising:
determining that a second DL transmission associated with one or more second periodic DL resources is to be received in one or more of the second subset of resource blocks associated with UL transmission;
determining that the one or more of the second subset of resource blocks associated with UL transmission are not available for DL receptions based on the indication; and
failing to monitor a control channel based on the determination that the second DL transmission associated with the one or more second periodic DL resources is to be received in the one or more of the second subset of resource blocks associated with UL transmission and the determination that the one or more of the second subset of resource blocks associated with UL transmission are not available for DL reception.

25. A WTRU comprising:
communication circuitry; and
a processor configured to:
receive, via the communication circuitry, an indication that each of one or more symbols include both a first subset of resource blocks associated with downlink (DL) reception and a second subset of resource blocks associated with uplink (UL) transmission;
receive, via the communication circuitry, a first DL transmission associated with one or more periodic DL resources in the one or more symbols on a condition that the one or more periodic DL resources are comprised in the first subset of resource blocks associated with DL reception for the one or more symbols; and
transmit, via the communication circuitry, a UL transmission associated with one or more periodic UL resources in the one or more symbols on a condition that the one or more periodic UL resources are comprised in the second subset of resource blocks associated with UL transmission for the one or more symbols.

26. The WTRU of claim 25, wherein the processor is further configured to receive, via the communication circuitry, configuration information indicating a plurality of UL/DL resource block patterns for the one or more symbols.

27. The WTRU of claim 26, wherein the plurality of UL/DL resource block patterns are indicated using a bitmap.

28. The WTRU of claim 26, wherein the indication is received via downlink control information (DCI) or a medium access control (MAC) control element (CE), and the indication indicates which of the plurality of UL/DL resource block patterns indicated in the configuration information is to be applied for the one or more symbols.

29. The WTRU of claim 28, wherein the indication indicates a first UL/DL resource block pattern of the plurality of UL/DL resource block patterns is to be applied for a first symbol of the one or more symbols, and the indication indicates a second UL/DL resource block pattern of the plurality of UL/DL resource block patterns is to be applied for a second symbol of the one or more symbols.

30. The WTRU of claim 26, wherein an RRC message comprises the configuration information.

31. The WTRU of claim 25, wherein the processor is further configured to:
receive, via the communication circuitry, an uplink grant for one or more second periodic UL resources in the one or more symbols;
determine that a second UL transmission associated with the one or more second periodic UL resources is to be transmitted in one or more of the first subset of resource blocks associated with DL reception;
determine that the one or more of the first subset of resource blocks associated with DL reception are not available for UL transmissions based on the indication; and
drop the second UL transmission based on the determination that the second UL transmission associated with the one or more second periodic UL resources is to be transmitted in the one or more of the first subset of resource blocks associated with DL reception and the determination that the one or more of the first subset of resource blocks associated with DL reception are not available for UL transmissions.

32. The WTRU of claim 25, wherein the periodic DL resources are for one or more of a physical downlink control channel (PDCCH) or a configured grant-physical downlink shared channel (CG-PDSCH).

33. The WTRU of claim 25, wherein the processor is further configured to:
determine that a second DL transmission associated with one or more second periodic DL resources is to be received in one or more of the second subset of resource blocks associated with UL transmission;
determine that the one or more of the second subset of resource blocks associated with UL transmission are not available for DL receptions based on the indication; and
fail to monitor a control channel based on the determination that the second DL transmission associated with the one or more second periodic DL resources is to be received in the one or more of the second subset of resource blocks associated with UL transmission and the determination that the one or more of the second subset of resource blocks associated with UL transmission are not available for DL reception.

34. A base station comprising:
communication circuitry; and
a processor configured to:
transmit, via the communication circuitry, an indication that each of one or more symbols include both a first subset of resource blocks associated with downlink (DL) reception and a second subset of resource blocks associated with uplink (UL) transmission;
transmit, via the communication circuitry, a first DL transmission associated with one or more periodic DL resources in the one or more symbols; and
receive, via the communication circuitry, a UL transmission associated with one or more periodic UL resources in the one or more symbols on a condition that the one or more periodic UL resources are comprised in the second subset of resource blocks associated with UL transmission for the one or more symbols.

35. The base station of claim 34, wherein the indication is transmitted via downlink control information (DCI) or a medium access control (MAC) control element (CE).
